(19) United States
(12) Patent Application Publication
(10) Pub. No.: US 2014/0172516 A1
(43) Pub. Date: Jun. 19, 2014

(54) SYSTEMS AND METHODS FOR STREAMLINING DATA COMPILATION AND REPORT GENERATION

(71) Applicant: John Tuck Davison, Reseda, CA (US)

(72) Inventor: John Tuck Davison, Reseda, CA (US)

(21) Appl. No.: 14/109,800

(22) Filed: Dec. 17, 2013

Related U.S. Application Data
(60) Provisional application No. 61/738,068, filed on Dec. 17, 2012.

(51) Int. Cl. G06Q 50/20; G06Q 10/06

(52) U.S. Cl. CPC G06Q 50/205; G06Q 10/06393
USPC 705/7.39

(57) ABSTRACT

The systems and methods for streamlining data compilation and report generation include storing one or more academic categories having one or more performance indicators in an electronic database, each performance indicator forming part of a sentence. A metric associated with each performance indicator forms another part of the sentence. The academic categories are displayed on a screen with the performance indicators and metrics associated therewith for selection by a user. Student information is then received and processed along with the selections of the academic categories, the performance indicators and the metrics from an interactive computer medium over a communication network. The received performance indicators are combined with each of the received metrics, and based on the student information, to create at least one complete sentence presentable in a student report measuring the academic performance of a student for one or more academic categories.

### BACKGROUND OF THE INVENTION

The present invention generally relates to systems and methods for streamlining data compilation and report generation. More specifically, the present invention relates to systems and methods for automatically generating individualized student assessment reports using multi-user data input and pre-created, user-designed descriptions and phrases.

Under the Individuals with Disabilities Act, every public school student with a disability receives an Individual Education Plan (“IEP”), alternatively called an Individualized Education Program. The purposes of the IEP are to assess the current performance of the student, set reasonable learning goals, and state the services the school system will provide. Among other things, the IEP must include two important parts: (1) The Present Level of Performance (“PLP”) that includes the student's strengths, weaknesses and how the disability affects the student academic and social performance; and (2) specific goals for each student that meet and target the student's needs, which are designed to incrementally improve the student's ability to meet academic standards. One drawback known in the art is the time required to create individualized PLP and goal reports that meet state and federal regulations based on data collected about each student.

Educators collect student data through several different methods such as observation, work samples, formal assessment, and meetings with parents. Once the educators collect all the student data, they use it to assess current performance level and to determine appropriate student goals. Individual educator hand compiled data, including student assessments and suggested goals, is inaccessible to other educators until reproduced in the form of a report with the student's PLP and goals. Often multiple educators provide input in the assessment and goal setting for a particular student, which presents a need to make collaboration easier. Presently, educators create these reports by hand. The process can take up to a week and is particularly problematic due to the lack of consistency among educators that provide input. As a result, the school system may provide unfair and inconsistent services in this respect.

There exists, therefore, a significant need for systems and methods for streamlining data compilation and report generation that increases efficiency in report generation, supports collaboration among multiple educators, and produces consistent reports even when multiple educators are involved. The systems and methods disclosed herein fulfill these needs and provide further related advantages.

### SUMMARY OF THE INVENTION

The systems and methods for streamlining data compilation and report generation disclosed herein include steps for inputting data into a machine readable medium and automatically generating an individualized report to enhance collaborative efforts for creating a vital part of an IEP; i.e., the individualized academic goals of a student PLP report. The systems and methods increase efficiency in report generation by implementing a computer programmed to automatically create reports from stored data, support collaboration among multiple educators by allowing multi-user access through a communication network-accessible computer, and producing consistent reports across multiple educator input. The systems and methods disclosed herein provide access to a central electronic database via a communication network to facilitate simultaneous multi-user access, input and report generation. The system processes user entered data related to subjects, strengths, needs/challenges and goals, teacher assessment monitoring, district/state assessment monitoring, disabilities, and impacts of those disabilities. Once data has been entered, the user can generate a standardized PLP report with goals. The user simply enters the student's name and gender, and then selects the appropriate PLP and goal data previously entered by one or more educators. This report is highly customizable based on the individualized need of each student, yet standardized across the entire school system. Once the user inputs and selects the appropriate data, the computer generates a report in a standard format ready for inclusion in the student IEP.

One method for streamlining data compilation and report generation includes storing one or more academic categories having one or more performance indicators in an electronic database. Each of the performance indicators are used as part of a sentence in a student academic report, as described below. In this respect, one or more metrics are associated with each of the performance indicators in the electronic database, the metrics being used as another part of the sentence in the student report. Each of the academic categories, the performance indicators and related metrics are displayed to a user via an interactive computer medium for selection. The next step is to receive student information and selections of the displayed academic categories, performance indicators and related selected metrics from the interactive computer medium over a communication network. Each of the received performance indicators are then combined with each of the received metrics and formed into at least one complete sentence presentable in a student report measuring an academic performance of the student for one or more academic categories. Additionally, the storing step may include storing a disability and one or more impacts related thereto. Accordingly, the displaying step may further include displaying the disabilities and related impacts via the interactive computer medium, wherein the combining step includes combining one or more selected disabilities and impacts into a complete sentence presentable in the student report.

Preferably, the receiving step includes receiving data communications from at least two remote devices over the communication network. This allows multiple users to work on compiling the student report simultaneously. Furthermore, this may also allow multiple users to simultaneously add, delete, or modify the student report through respective interactive computer mediums. The performance indicator may include an academic strength or an academic weakness and the metric may include a grade having a percentage or a fractional score. A monitoring assessment including a pass or fail indicator may also be stored in the electronic database along with the academic category, performance indicators and related metrics. Selected monitoring assessments may be presented in the student report when generated. As part of the report generation, the system may inject a variable field into the sentence, the variable field fillable based on the student information submitted by the remote device. In this respect, the system may analyze the student information to determine the student's gender, and then the system may generate at least one gender-based pronoun usable in the complete sentence, thereby filling the variable field. Of course, the system may print the student report or present the student report to the interactive computer medium, such as a computer monitor or a smartphone. The system may further form a student academic profile including student reports from multiple grade levels.

In a further aspect of this embodiment, the method may include compiling the student report from multiple remote devices simultaneously over the communication network. Here, the system may establish multiple data connection requests in a central server with the multiple remote devices. The central server preferably receives and processes the student information, selections of the academic categories, the performance indicators, and/or the metrics simultaneously over the communication network. This central server may further communicate with a standards server over the communication network for updating the categories, performance indicators and related metrics for conforming to federal, state or local regulations. The electronic database and communication network may include security features that include a first security level permitting adding, deleting or modifying information in the electronic database and a second security level with read only privileges.

In another embodiment, the method for streamlining data compilation and report generation includes steps for storing one or more academic categories having one or more performance indicators in an electronic database, each of the one or more performance indicators including an academic strength or an academic weakness and forming a part of a sentence thereof. The performance indicators are preferably associated with one or more metrics, each of the metrics including a grade that includes a percentage or a fractional score forming another part of the aforementioned sentence thereof. The one or more academic categories, one or more performance indicators and metrics associated therewith are displayed to a user via an interactive computer medium. User selected academic categories, performance indicators and metrics are received by a server from at least two remote devices over a communication network and the received performance indicators are combined with each of the received metrics and based on the student information, into at least one complete sentence presentable in a student report measuring an academic performance of a student for one or more of the academic categories. A variable field may be injected into the sentence, wherein the variable field is fillable based on the student information when presented in the student report. The system communicates with a standards server over the communication network to ensure that the categories, performance indicators and metrics remain updated for purposes of conforming to federal, state or local laws.

The storing step may further include the step of storing at least one monitoring assessment including a pass or a fail indicator and displaying the selected monitoring assessment via the interactive computer medium along with the academic categories, performance indicators and metrics. Preferably, the selected monitoring assessment is included in the student report, as described above. The storing step may also include storing a disability and one or more impacts related thereto in the electronic database, for displaying through the interactive computer medium. One or more selected disabilities and related impacts are then combined into a complete sentence presentable in the student report. The student report may be compiled from at least two remote devices simultaneously over the communication network, and may permit simultaneously adding, deleting, or modifying the student report.

Furthermore, this embodiment may further include steps for generating a teaching feedback form and printing the student report or presenting the student report to the interactive computer medium, wherein the interactive computer medium includes a computer monitor or a touch screen. The method may also include translating the student information into at least one gender-based pronoun usable in the complete sentence as the variable field, forming a student academic profile including a student report from multiple grade levels, and securing the electronic database and the communication network into a first security level permitting adding, deleting or modifying information in the electronic database and a second security level with read only privileges.

In another aspect of the systems and methods described herein, the data compilation streamlining and report generation process includes storing one or more academic categories having one or more performance indicators, at least one monitoring assessment, and at least one disability in an electronic database, each of the performance indicators, monitoring assessments, and disabilities form a part of one or more sentences to be used in association with a student academic report. The next step includes associating one or more metrics with each of the one or more performance indicators and associating one or more impacts with each of the disabilities, each of the metrics and the impacts are used as another part of the sentences to be included in the report. The academic categories, performance indicators (with at least one metric), and the disabilities (with at least one impact) are displayed via an interactive computer medium for user review and selection. The central computer system then receives student information (e.g., name, gender, grade level, etc.), selections of one or more academic categories, one or more performance indicators (with at least one metric), at least one monitoring assessment, and at least one disability (with at least one impact) from the interactive computer medium (e.g., a computer monitor or a touch screen) over a communication network. Each of the received performance indicators are combined with each of the received metrics and each of the selected disabilities are combined with each of the received impacts into one or more complete sentences presentable in a student report measuring an academic performance of a student for one or more academic categories, along with the selected monitoring assessment.

The system may permit the compiling of a student report from at least two remote devices simultaneously over the communication network. This step inherently allows the central computer system to receiving data communications from at least two remote devices via a communication network. The two remote devices preferably connect via a web-based software application that communicates with the central computer or server. This feature may also permit two users to simultaneously add, delete, or modify the student report through respective interactive computer mediums, and such users may also simultaneously print the student report or present the student report via respective interactive computer mediums. Over time, the system may form a student academic profile that includes a student report from multiple grade levels.

The process may further include injecting a variable field into the sentences, the variable field fillable based on the student information when presented in the student report. The student information may be translated into at least one gender-based pronoun usable in the complete sentence as the variable field. Additionally, the central server may receive the student information, selections of academic categories, performance indicators and related metrics, disabilities and related impacts, and the monitoring assessment from multiple devices simultaneously over the communication network. Preferably, the electronic database and the communication network are secured into at least a first security level permitting adding, deleting or modifying information in the electronic database and a second security level with read only privileges. To keep the system updated, the electronic database may be updated by way of communicating with a standards server over the communication network, the standards server provides informational updates to the academic categories, performance indicators and associated metrics, the monitoring assessments, and disabilities and associated impacts over the communication network.

The process disclosed herein has the additional capability of automatically creating an optional “Teacher Feedback Sheet” by compiling data and generating a form to be given to a student's teacher. This sheet allows the teacher to gather important data about a student's strengths, which must be assessed in order to create the PLP and goals required for the IEP.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flowchart illustrating the process by which a user interfaces with the systems and methods disclosed herein for streamlining data compilation and report generation;

FIG. 2 is a webpage screenshot illustrating a system welcome screen;

FIG. 3 is a webpage screenshot illustrating an exemplary add/view bubble providing links to webpages for adding or viewing needs/challenges & goals;

FIG. 4 is a webpage screenshot illustrating an add subjects page;

FIG. 5 is a webpage screenshot illustrating a subject summary page;

FIG. 6 is a webpage screenshot illustrating an add strengths page;

FIGS. 7A-7F illustrate a website screenshot of a strengths summary page displaying a series of strengths and corresponding combined parts related to geometry, algebra, reading, writing, English language development (ELD) and behavior;

FIG. 8 is a website screenshot illustrating an add needs/challenges & goals page;

FIGS. 9A-9F illustrate a website screenshot of a view needs/challenges & goals summary page displaying a series of needs/challenges & goals and corresponding goals related to geometry, algebra, reading, writing, English language development (ELD) and behavior;

FIG. 10 is a website screenshot illustrating an add teacher assessment monitoring page;

FIG. 11 is a website screenshot illustrating a teacher assessment monitoring summary page;

FIG. 12 is a website screenshot illustrating an add district/state assessment monitoring page;

FIG. 13 is a website screenshot illustrating a district/state assessment monitoring summary page;

FIG. 14 is a website screenshot illustrating an add disability page;

FIG. 15 is a website screenshot illustrating a disability summary page;

FIG. 16 is a website screenshot illustrating an add impact of disability page;

FIG. 17 is a website screenshot illustrating an impact of disability summary page;

FIGS. 18A-18B illustrate a website screenshot of a report generation page where reports are selected by subject;

FIGS. 19A-19L further illustrate the report generation page of FIGS. 18A-18B during report preparation;

FIGS. 20A-20B illustrate a website screenshot of a printable report generated from the report generation page illustrated in FIGS. 19A-19L;

FIGS. 21A-21B illustrate a website screenshot of a teacher feedback page;

FIGS. 22A-22C further illustrate the teacher feedback page of FIGS. 21A-21B for creating an individualized teacher feedback form based on selected individual student strengths;

FIGS. 23A-23E alternatively illustrate the teacher feedback of FIGS. 21A-21B for creating an individualized teacher feedback form;

FIG. 24 is a website screenshot of a printable teacher feedback page; and

FIG. 25 is a diagram of a preferred communication network used in association with the embodiments disclosed herein.

### DETAILED DESCRIPTION OF THE PREFERRED EMBODIMENTS

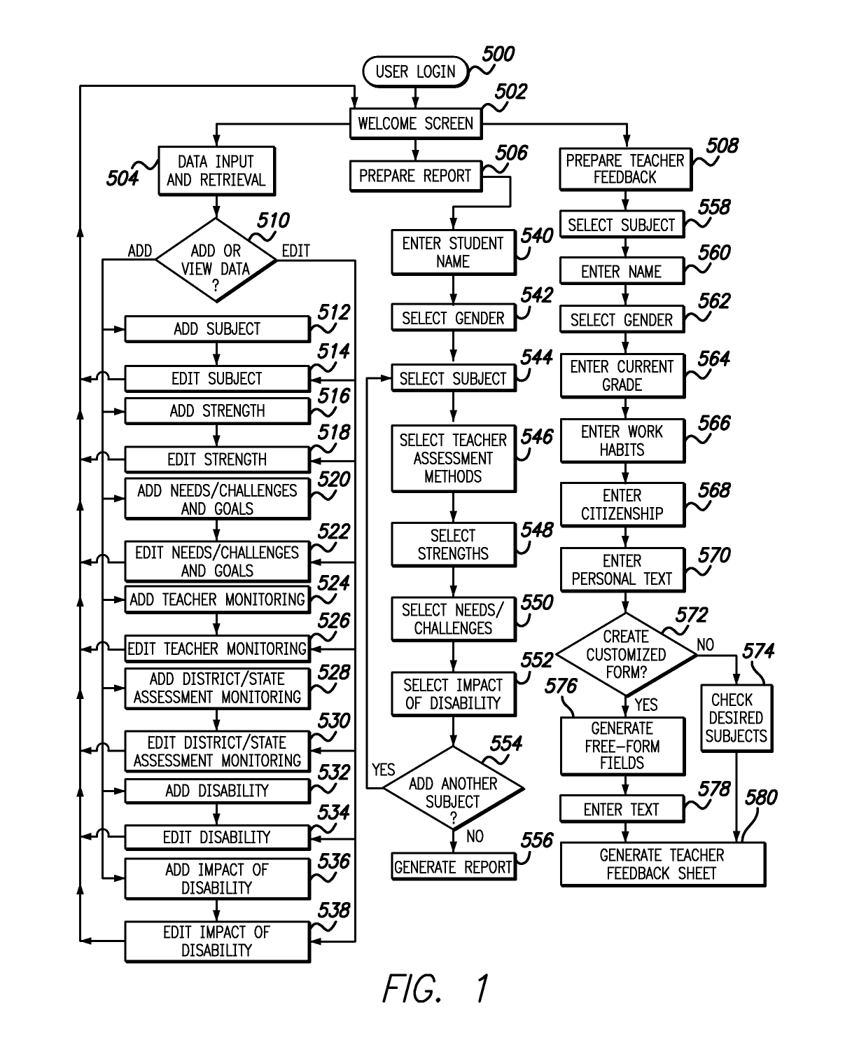

As shown in the drawings for purposes of illustration, the present invention relates to systems and methods for streamlining data compilation and report generation to increase efficiency in IEP report generation, support collaboration among multiple educators, and produce consistent IEP reports when receiving input from multiple educators. More specifically, FIG. 1 is a flowchart illustrating a series of preferred steps for performing and completing data compilation and report generation. In this embodiment, the systems and methods may be provided in the form of a web-based software application designed for use with a computer, laptop, netbook, tablet computer, web-enabled smartphone, or virtually any device capable of processing and accessing information over a communication network. In this respect, the system stores PLP and goal data in a common electronic database simultaneously and remotely accessible by authorized users. Educators are able to access and track student data to create individualized student reports as the student moves throughout the school system. For example, student PLP report may be accessible first by an elementary school teacher, and then later accessed by a middle school or high school teacher. This gives educators at various levels within the school system the option obtain, input and select appropriate data for each student for inclusion in the report. The Internet accessible nature of the system disclosed herein allows educators to view, edit and add to the database, including PLP and goal data. Any credentialed educator with Internet or other communication network access may generate individualized student reports by using the processes disclosed herein, regardless of physical location.

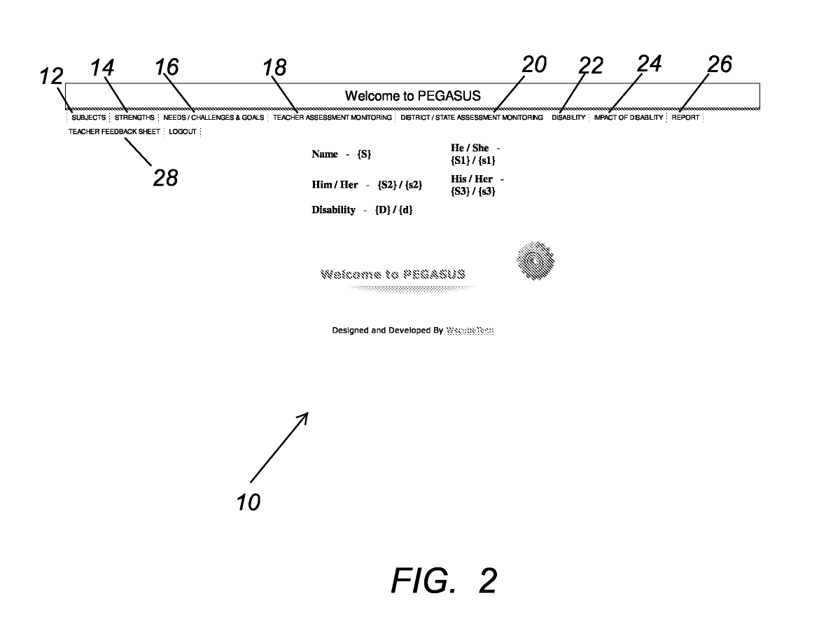

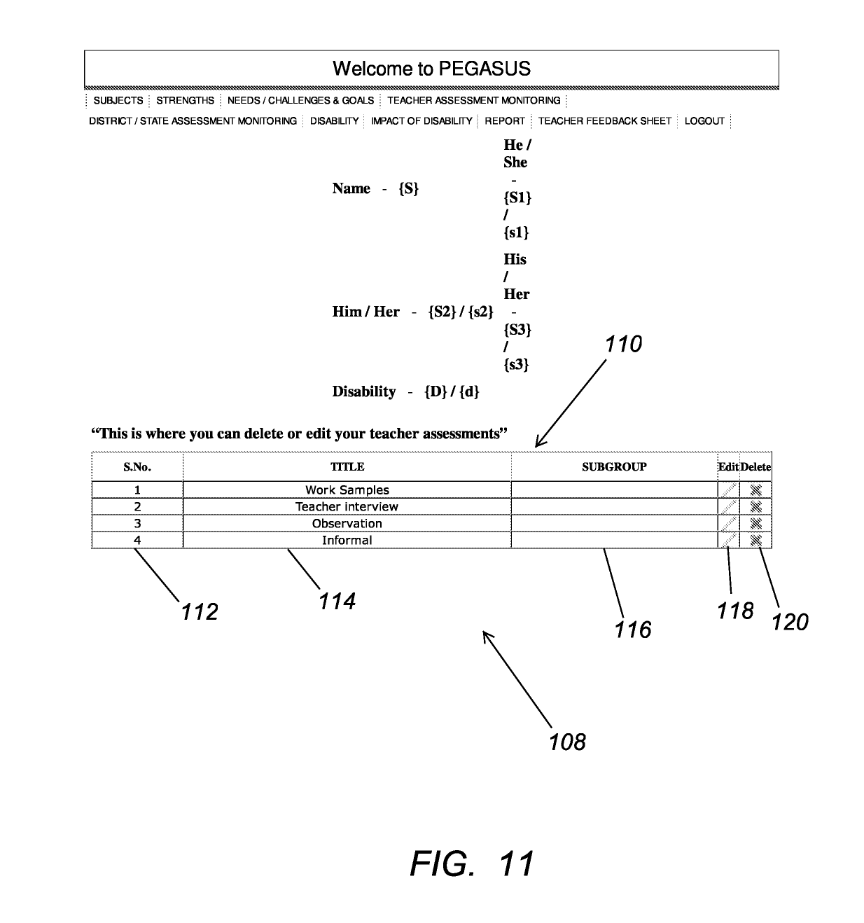

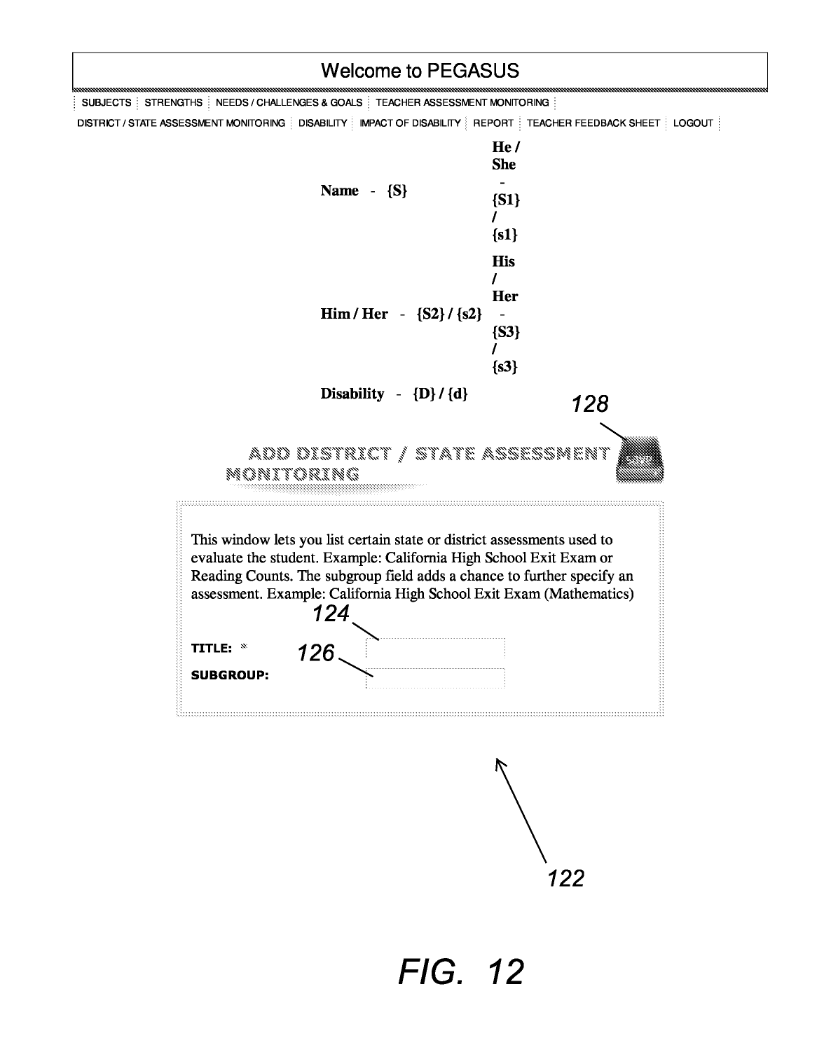

Accordingly, FIGS. 2-24 more specifically illustrate the above-mentioned systems and methods in a preferred series of Internet accessible webpages. While this information is preferably accessible via the Internet, a person of ordinary skill in the art will recognize that this information may be accessible and processed through more secure communication networks, such as local school intranets, wide area networks, or local area networks. Additionally, the communications network may include cable, Ethernet, T1, fiber optic, telephone line, or another data communication network designed to exchange information in and among client or server computers. The important aspect is that users be able to interface with these electronic pages to facilitate the input and generation of student reports.

One advantage of the system described herein is the ability to automatically generate custom, yet standardized individual student reports based on standard user input. That is, the system is able to generate standardized PLP reports based on input from various users in the school system. This eliminates discrepancies and other inconsistencies that arise when different educators do evaluations and assessments. The standardized PLP and goal data is stored in a commonly accessible database to facilitate collaboration among authorized educators. Preferably, the system may restrict user access to certain student data depending on authorization credentials. For example, a high school Principal may have access to all PLP and goal data for all students in the school system, while certain teachers or administrators, such as counselors, may have restricted access to student data based on the students assigned to them.

Student testing results and evaluations are entered and stored into the system under categories that include: subject, strengths, needs/challenges & goals, teacher assessment monitoring, district/state assessment monitoring, disability, and impact of disability. These categories could, of course, change depending on city, state or federal regulation requirements. Each category includes one or more required fields that include, e.g., single words, short phrases, or sentence fragments, as described in more detail below. The system uses the data input into these fields to generate reports. The streamlined process of handling data saves significant time and improves efficiency by pre-programming education goals corresponding to and based on student evaluation data.

In this respect, FIG. 1 is a flowchart illustrating one embodiment of a preferred system and method disclosed herein. The flowchart illustrates system operation when a user gains access via one of the aforementioned communication networks for inputting the necessary PLP and goal data or generating an individualized student report or optional teacher feedback sheet. The first step in this process is for the user to login to the system (500). Users are required to input a username and password as is generally well known in the art. Users initially not registered with the system may also have an opportunity to sign up with the system through this login screen in order to obtain access. Once logged in, users are directed to a welcome screen 10 (FIG. 2) that displays a series of tabs at the top that include a subject tab 12, a strengths tab 14, a need/challenges & goals tab 16, a teacher assessment monitoring tab 18, a district/state assessment monitoring tab 20, a disability tab 22, an impact of disability tab 24, a report tab 26, and a teacher feedback sheet tab 28. Users navigate the system through selection of these tabs by virtue of selecting hyperlinks available on the screen.

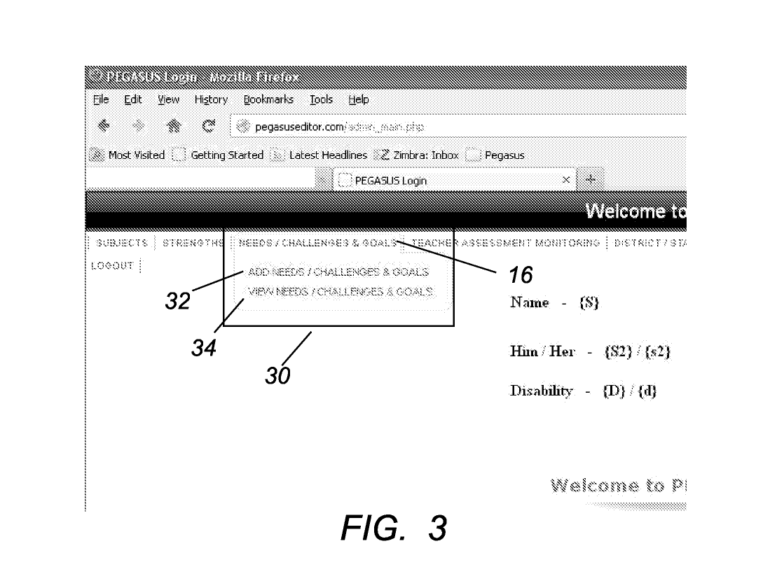

The next step in the process is to select one of the tabs 12-28 shown at the top of the welcome screen 10 in FIG. 2 during step (502). Tab selection (502) is generally organized by three different selection options: (a) selecting data input and retrieval as part of step (504); (b) preparing a report as part of step (506); or (c) preparing a teacher feedback sheet as part of step (508). Steps (506) and (508) may only be completed if data has been entered into the system; otherwise the report and feedback sheet will be empty. Therefore, at least initially, users need to input data into the system as part of step (504). For each of the tabs 12-24, the user needs to decide whether to add data or view data as part of decision step (510). In this respect, FIG. 3 illustrates one such embodiment that includes a bubble 30 displaying an “add” link 32 and a “view” link 34 extending out from the needs/challenges & goals tab 16. In this case, the add link 32 and the view link 34 correspond to selections for respectively adding or viewing needs/challenges & goals. Similar “add” and “view” links are available for each of the subject tab 12, the strengths tab 14, the teacher assessment monitoring tab 18, the district/state assessment monitoring tab 20, the disability tab 22 and the impact of disability tab 24. Each of these “add” and “view” links are not shown separately for the sake of eliminating redundancy. But, a person of ordinary skill in the art will readily recognize that these links will direct users to unique webpages, as described in more detail below.

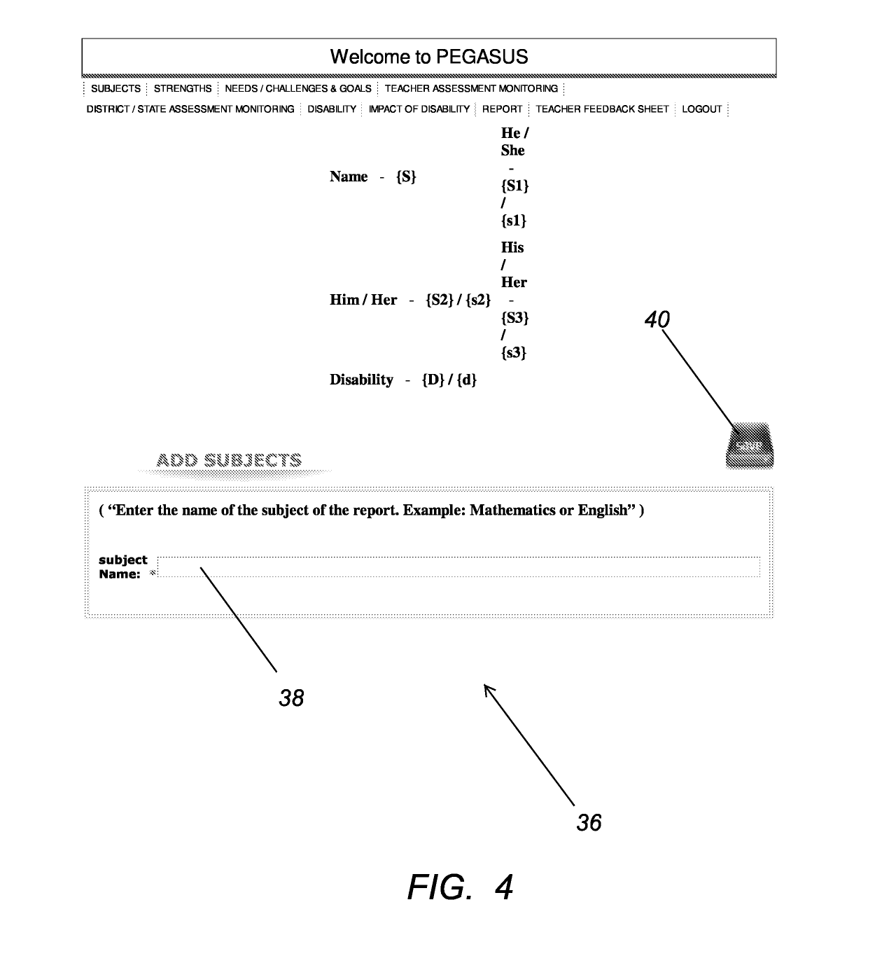

To add data, the user must select an “add” link accessible from one of the desired tabs 12-24. For example, to add a subject (512), a user selects the appropriate “add” link under the subjects tab 12. Said link will become visible in a bubble comparable to bubble 30 (FIG. 3) when moving the mouse cursor over the subjects tab 12. In this respect, FIG. 4 illustrates a webpage screenshot of an add subjects page 36, which displays an input field 38 where the user may enter a new subject. Here, the user has the ability to enter the name of a subject to be included in the student report. Example subjects might include mathematics or English. Once the subject is entered into the input field 38, the user selects a save button 40 and the system stores the subject data on the host computer or server in a machine readable data storage medium for later retrieval in populating fields and drop down boxes, as described in more detail below.

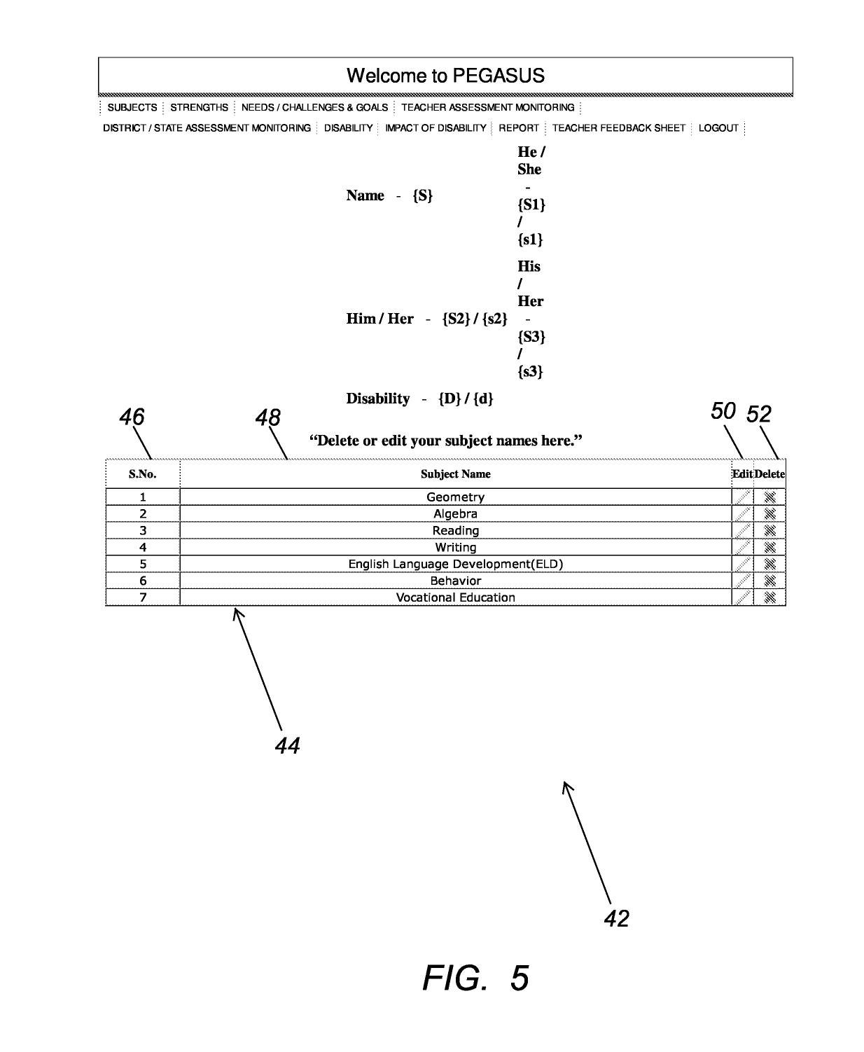

Once the data is saved as part of step (512), the user is next directed to a subject summary page 42 listing each of the entered subjects, as shown in FIG. 5, for editing or deleting the subjects (514). For example, the subjects are listed in a chart 44 that includes a subject number column 46, a subject name column 48, an edit column 50, and a delete column 52. In one embodiment, the subjects listed in the chart 44 may be organized or sorted (or reverse sorted) by order of entry as identified in the subject number column 46 or the subjects may be organized alphabetically in the subject name column 48. This may be accomplished by clicking on the column heading or a sort button (not shown). Furthermore, the subject summary page 42 displays the list of subjects entered as part of step (512) in the subject name column 48 with the option to edit or delete each subject in accordance with step (514) by selecting the corresponding icon in the edit column 50 or the delete column 52. If the user chooses to edit a particular subject, the user is directed back to the add subjects page 36 shown in FIG. 4 with the input field 38 pre-populated with the corresponding subject to be edited. Here, the user has the option to edit the name of the subject and re-save in the same manner as step (512). Accordingly, the user is then directed back to the subject summary page 42 illustrated in FIG. 5, with the newly entered name reflected in the subject name column 48.

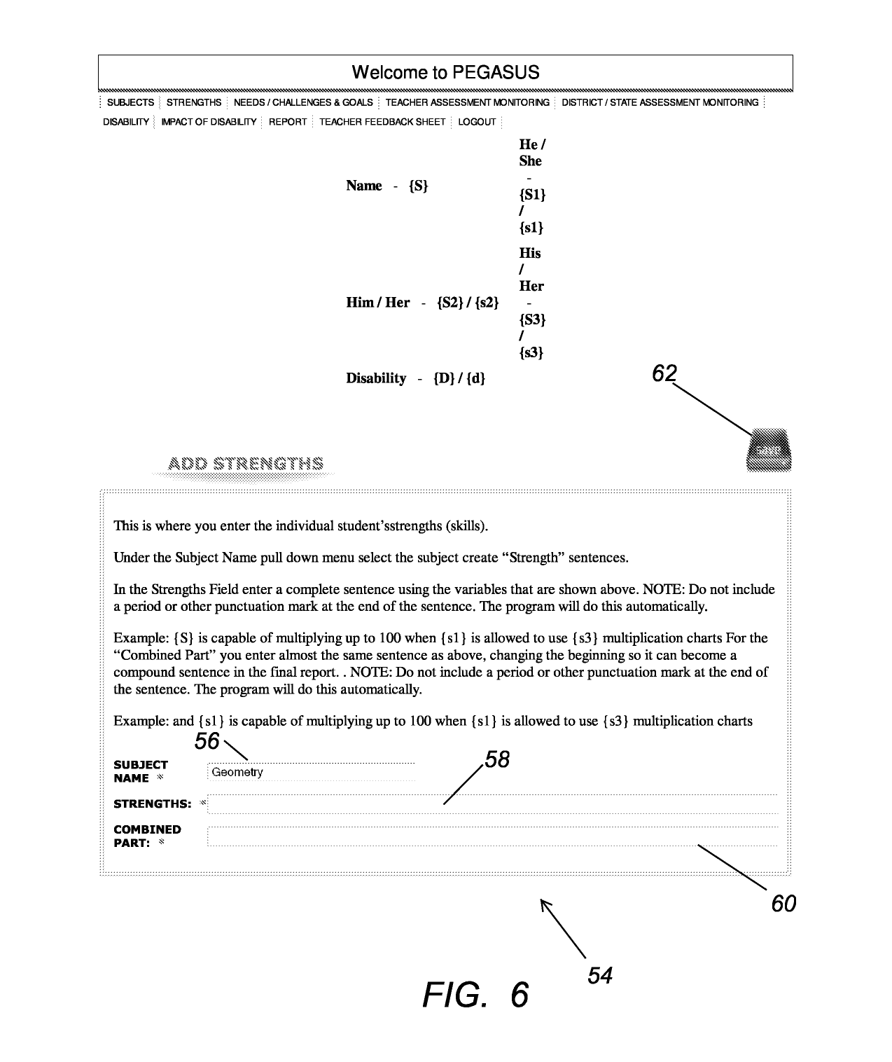

The next step is to add strengths (516). This is accomplished by first selecting the “add” link provided in a comparable bubble as described above. Doing so takes the user to an add strengths page 54 as shown in FIG. 6. Specifically, FIG. 6 displays a webpage that includes a subject dropdown box 56 populated with data entered into the input field 38 and saved during step (512). Furthermore, FIG. 6 illustrates two additional input fields, a strengths input field 58 and a combined part input field 60. First, users select the applicable subject from the subject dropdown box 56. The next step is to enter the strength and combined part data (i.e., the PIP data) as part of step (516). For example, in the strengths input field 58, the user enters a complete sentence regarding student strengths or skills. Variables such as “{S}” may represent the student's name and “{D}” may automatically populate the disability. Preferably, the program itself will create a period at the end of the sentence entered into the strengths input field 58. The combined part input field 60 allows the user to enter the same or similar sentence as entered into the strengths input field 58, but doing so in a manner that allows it to become integrated with other language as part of a compound sentence. For example, entering “{S} is capable of multiplying up to 100 when {s1} is allowed to use {s3} multiplication charts” may produce the following sentence: “Joe is capable of multiplying up to 100 when he is allowed to use his multiplication charts”. In this example, {S} is a variable field representative of the student's name (Joe) and {s1} and {s3} are variable fields for the pronouns “he” and “his”, respectively.

The information in the input fields 58, 60 is then stored in association with the selected subject in the subject dropdown box 56 when the user selects the save button 62. Any authorized user may then retrieve this information from the database at a later date. Preferably, the database is multi-user accessible and updates in real time so multiple users are able to input, update, store, retrieve and access information simultaneously. Users may then repeat the process with respect to step (518) to add strengths for each subject. Preferably, each subject includes multiple strengths, as shown below.

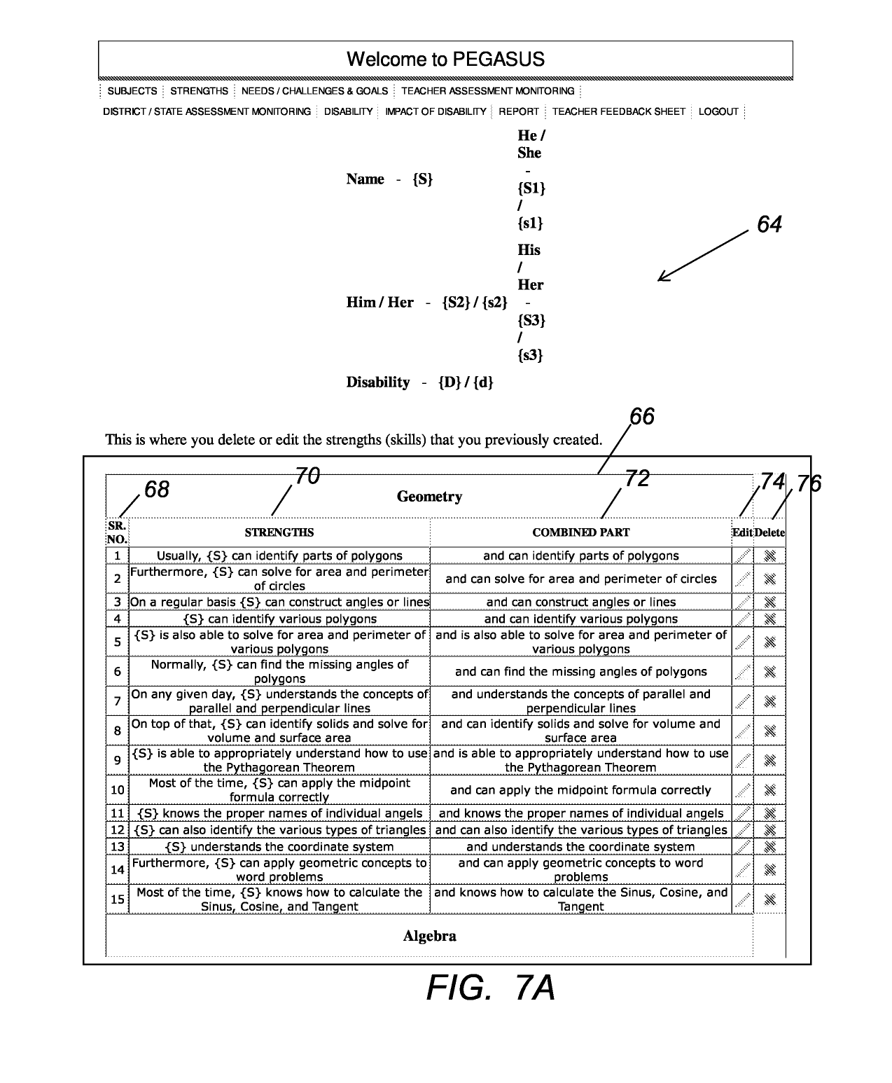

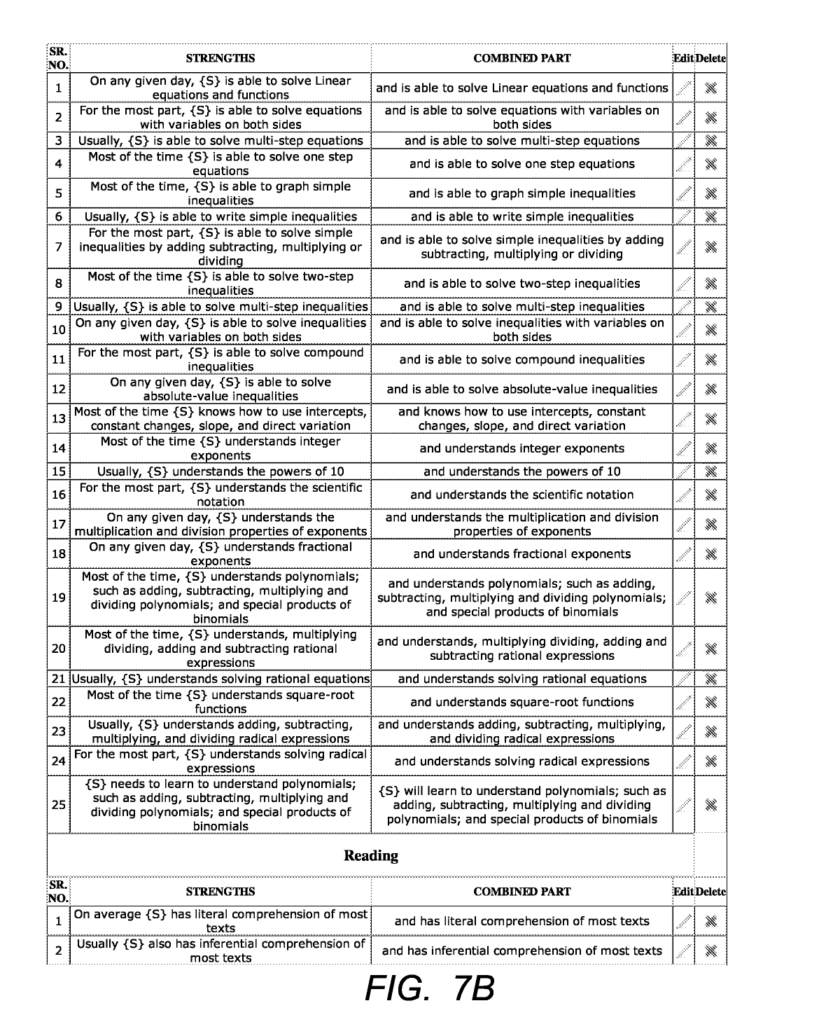

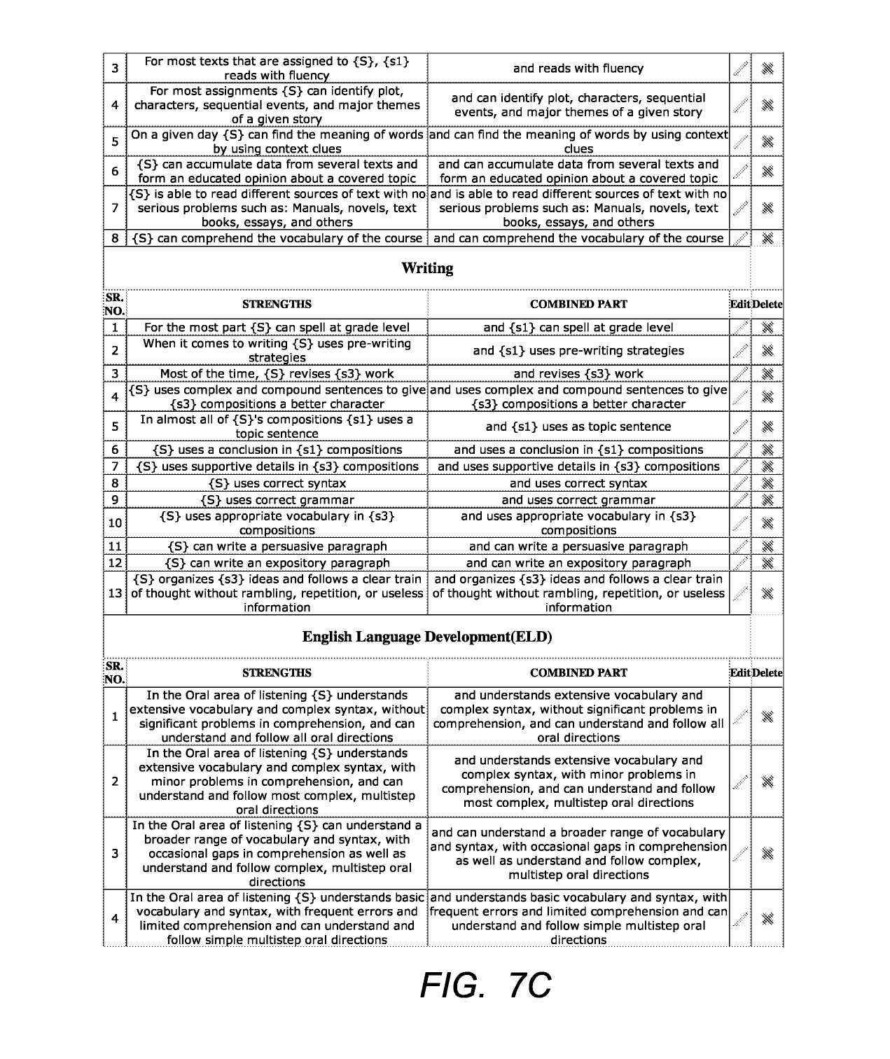

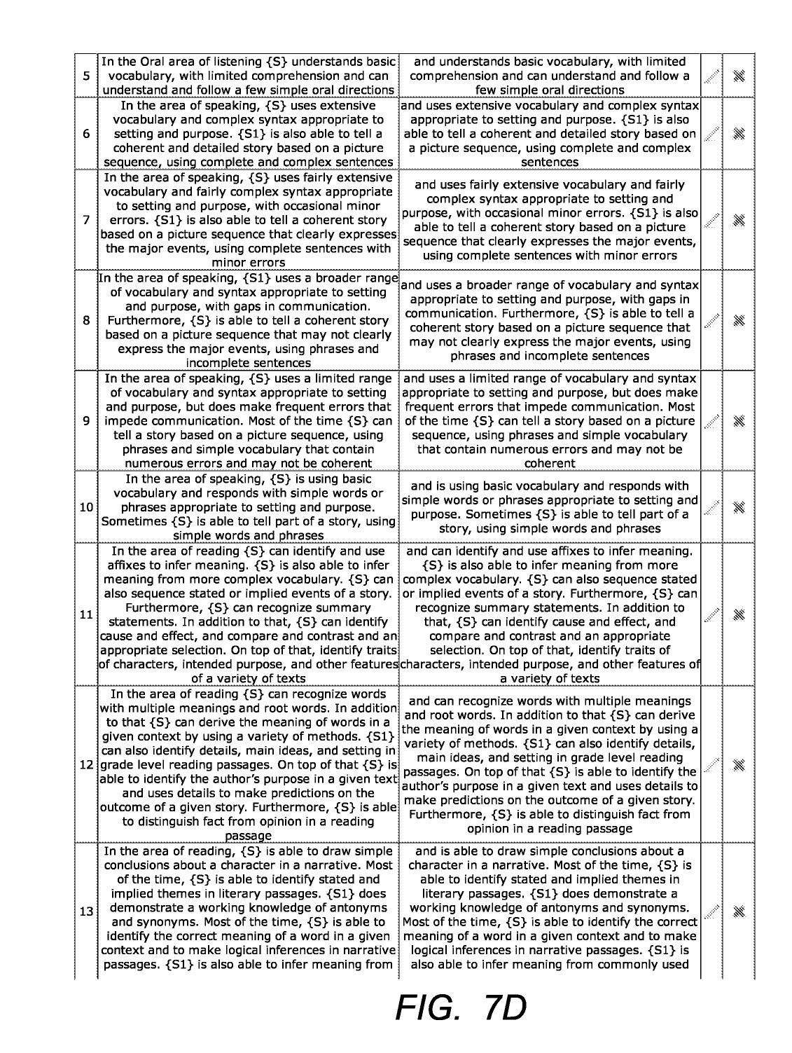

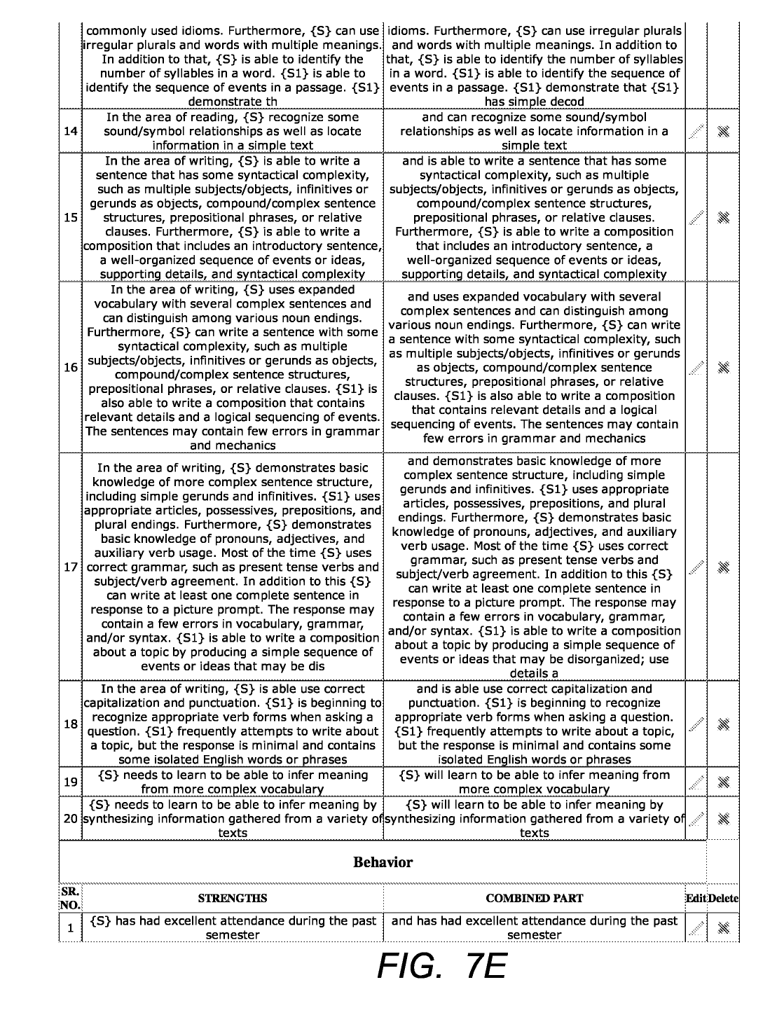

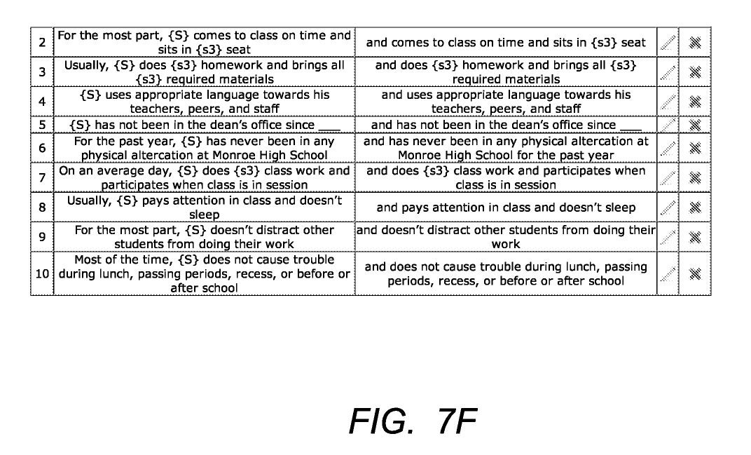

The information input into the system as part of steps (512) and (516) is accessible via a strengths summary page 64, as generally shown with respect to FIGS. 7A-7F. Here, each of the strengths and combined parts entered as part of step (518) are reproduced in an organized manner by each subject entered as part of step (512) (e.g., Geometry, Algebra, Reading, Writing, English Language Development (ELD), and Behavior) in a chart 66. Specifically, the chart 66 includes a strengths number column 68, a strengths column 70, a combined part column 72, an edit column 74, and a delete column 76. Preferably, the chart 66 is organized first by the order subjects are entered pursuant to step (512), followed by the order of entry for each corresponding strength, as denoted in the strengths number column 68. Although, a person of ordinary skill in the art will recognize that the information in the chart 66 could be organized and sorted by virtually any criteria. As shown in FIGS. 7A-7F, the system displays a list of strengths entered into the strengths input field 58 and the combined part input field 60 as part of step (516) and reproduces those saved entries into the organized chart 66. The user may edit or delete the strengths and combined parts (518) in a process similar to the manner described above for the editing or deleting of subjects as part of step (514). That is, selecting an “edit” icon corresponding to a strength and combined part takes the user back to the add strengths page 54 with pre-populated data in the subject dropdown box 56, the strengths input field 58 and the combined part input field 60. Here, the user may make any changes necessary and re-save the data by selecting the save button 62. At this point, the user is taken back to the strengths summary page 64 with the newly saved information updated in the chart 66. Additionally, a strengths and corresponding combined part may be deleted by selecting the corresponding icon in the delete column 76.

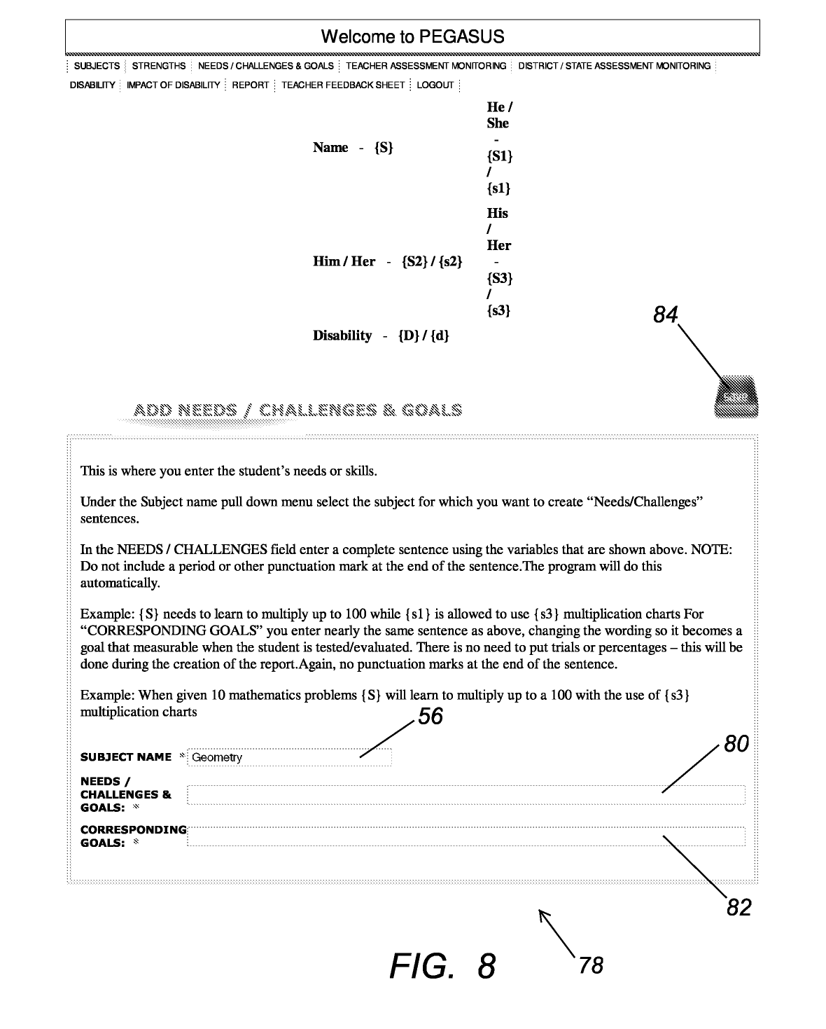

The next step is to add needs/challenges & goals (520). This step is accomplished by first selecting the “add” link in the bubble associated with the needs/challenges & goals tab 16. This takes the user to a needs/challenges & goals page 78 as shown with respect for FIG. 8. Here, the user adds needs/challenges & goals (520) by completing a process similar to that for adding strengths (516). Specifically, the user selects a subject from the subject drop down box 56 for which needs/challenges & goals sentences will be created. Next, the user adds a complete sentence using the previously described variables into a needs/challenges & goals input field 80 and a goals input field 82. Again, the user is not required to include a period or other punctuation at the end of the sentence as the program inserts said punctuation automatically. For example, entering “{S} needs to learn to multiply up to 100 while {s1} is allowed to use {s3} multiplication charts” for a student named “Joe” will produce “Joe needs to learn to multiply up to 100 while he is allowed to use his multiplication charts” in the student report. The information entered into the goals input field 82 is preferably substantially similar to the information added to the needs/challenges & goals input field 80, with minor changes to the sentence structure so the goal is measurable when the student is tested and/or evaluated. There is no need to input trials or percentages at this step as these are entered during report creation. For example, for student “Joe”, the sentence “When given 10 mathematics problems {S} will learn to multiply up to a 100 with the use of {s3} multiplication charts” translates into “When given 10 mathematics problems Joe will learn to multiply up to a 100 with the use of his multiplication charts” during the report creation step, as described in more detail below. Of course, when the user is finished entering the information into the respective input fields 80, 82, the information is saved into the computer electronic database by selecting a save button 84.

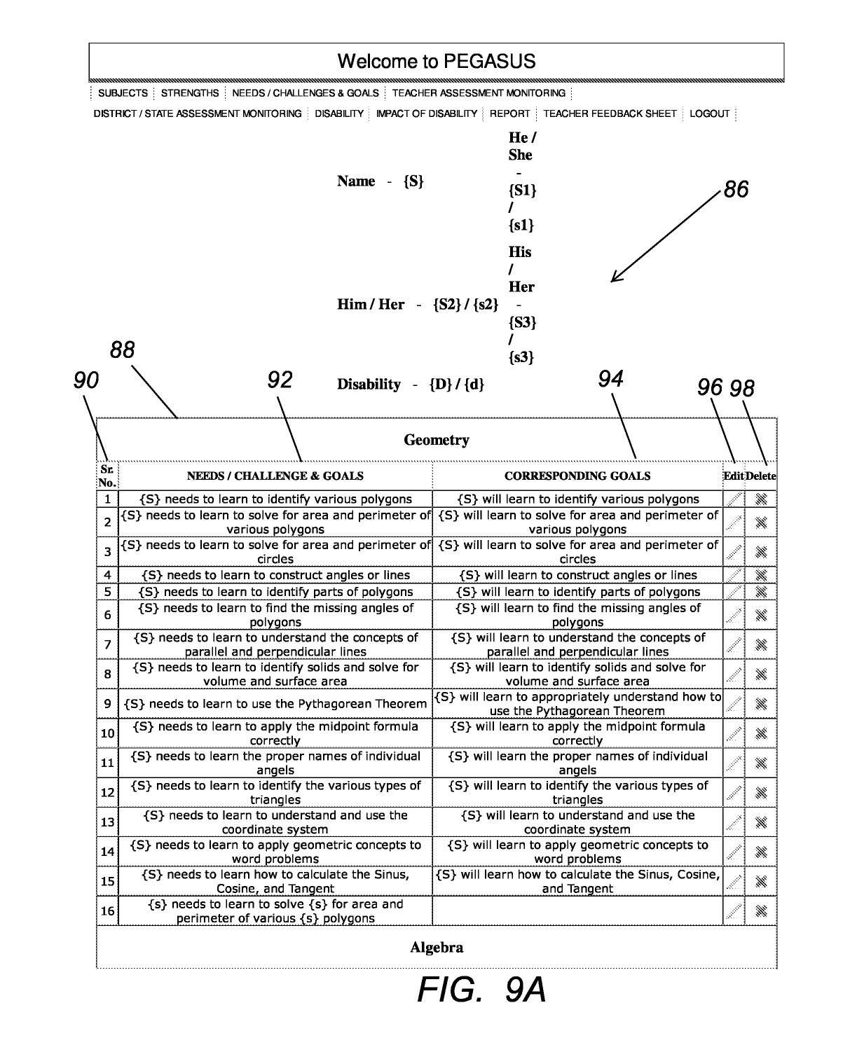

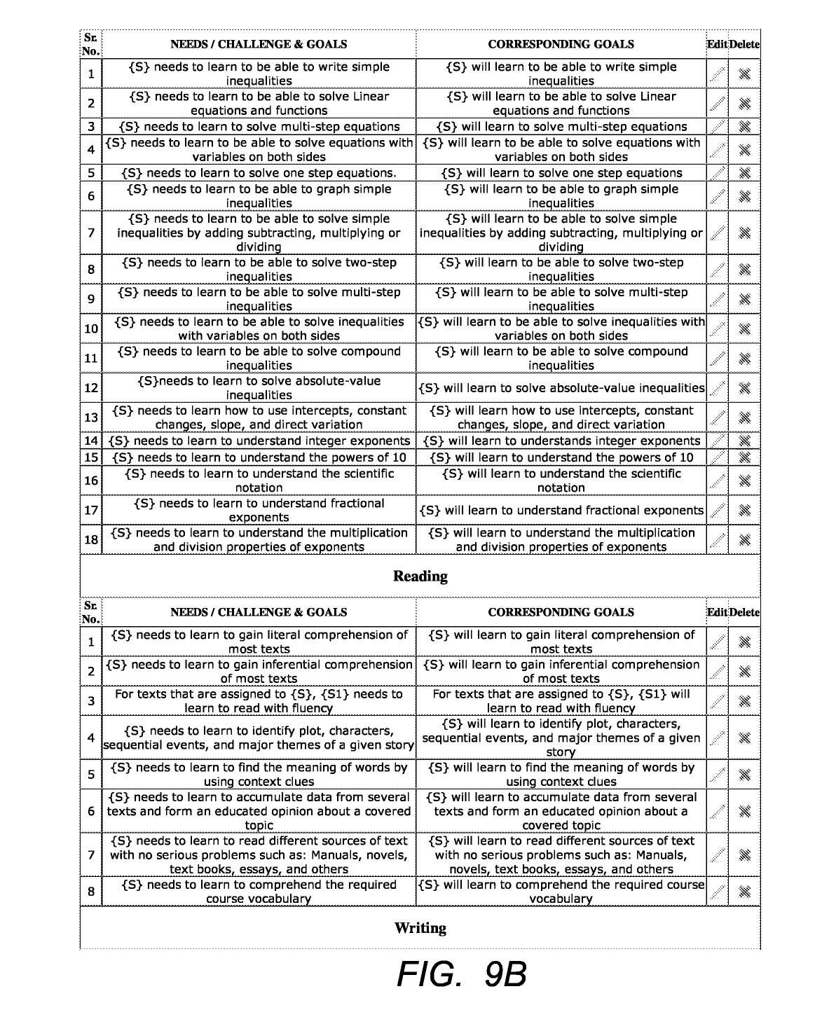

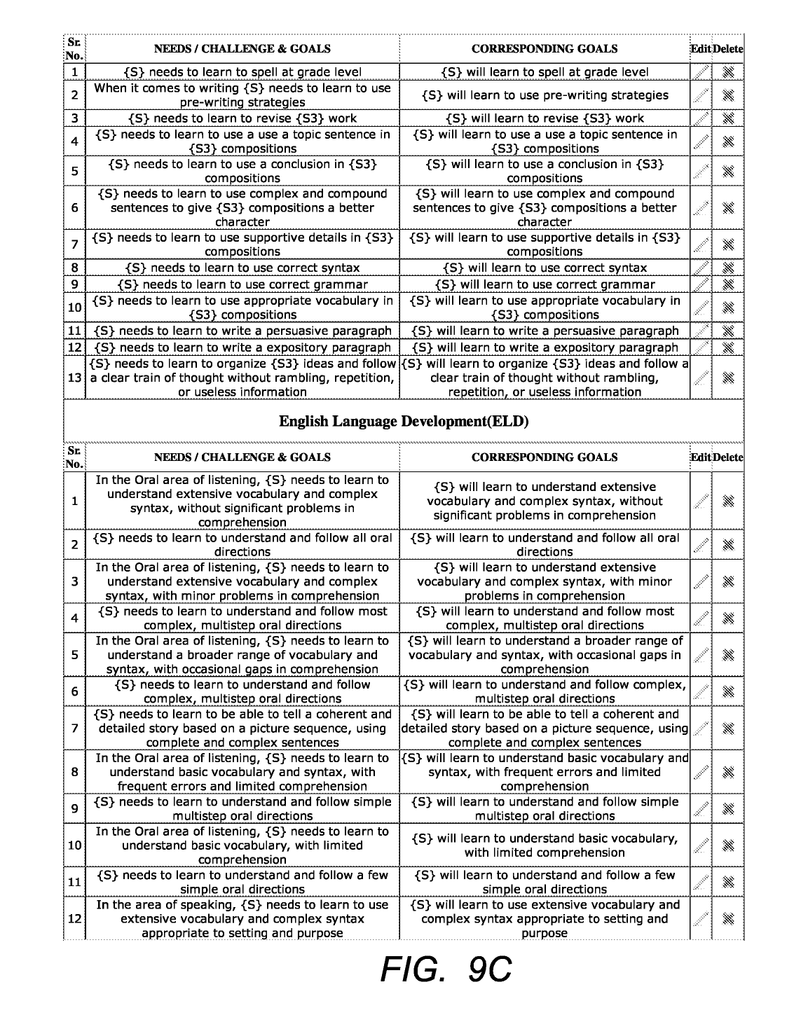

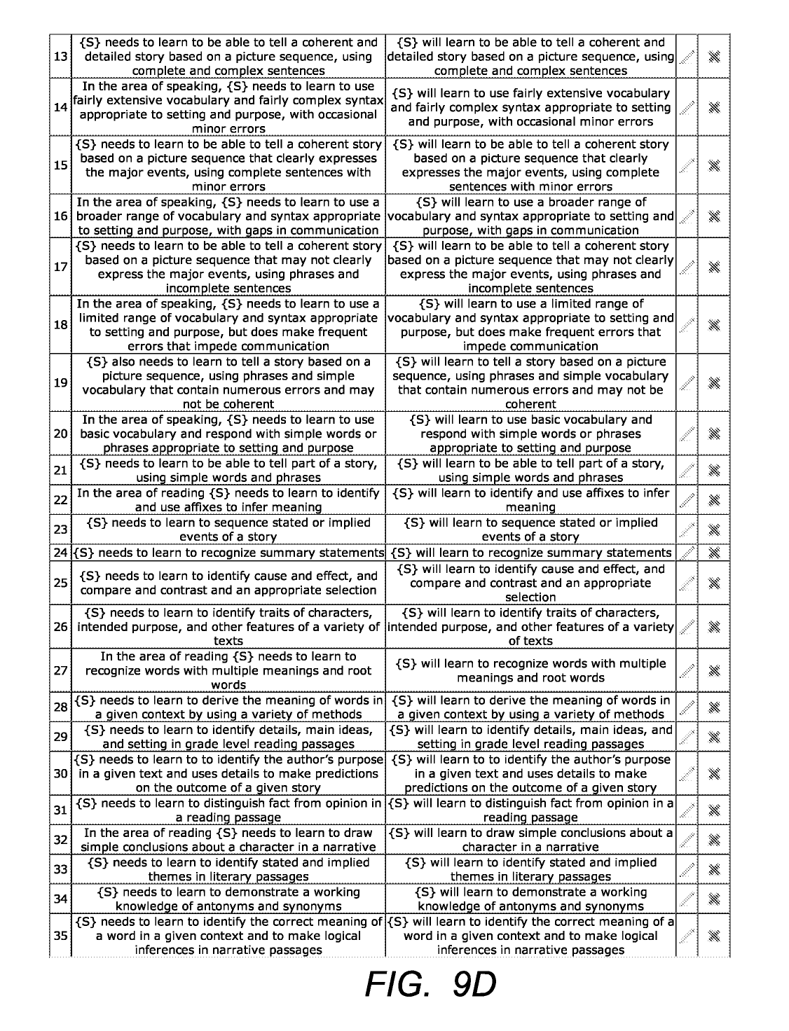

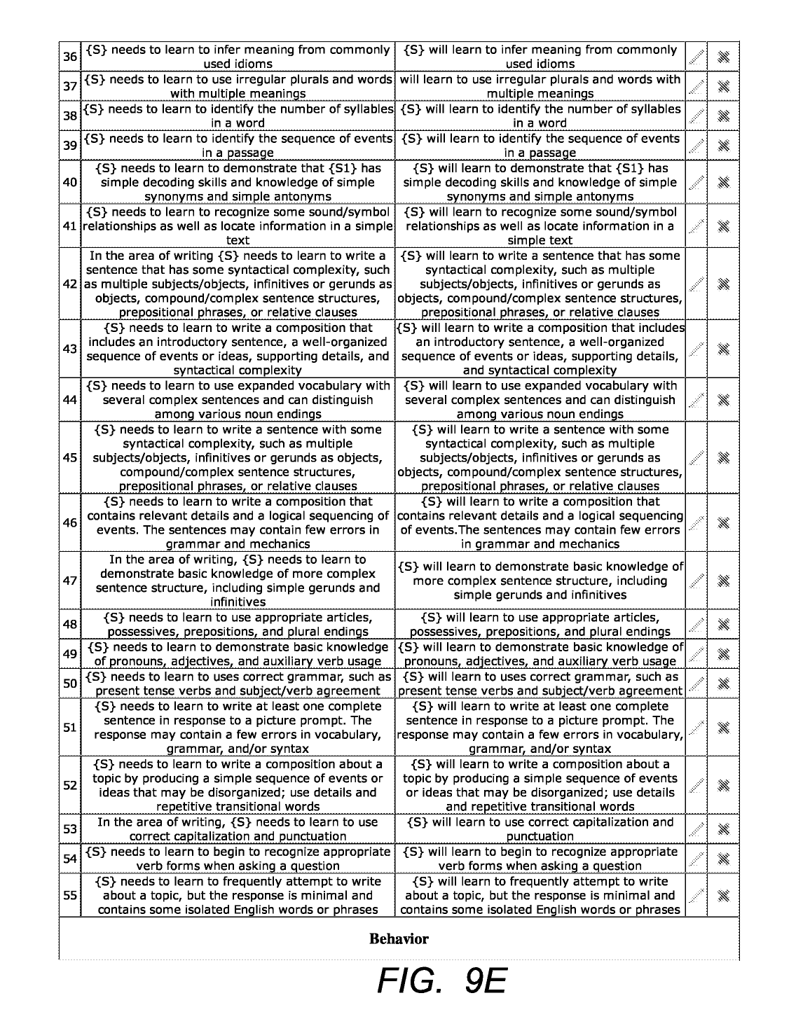

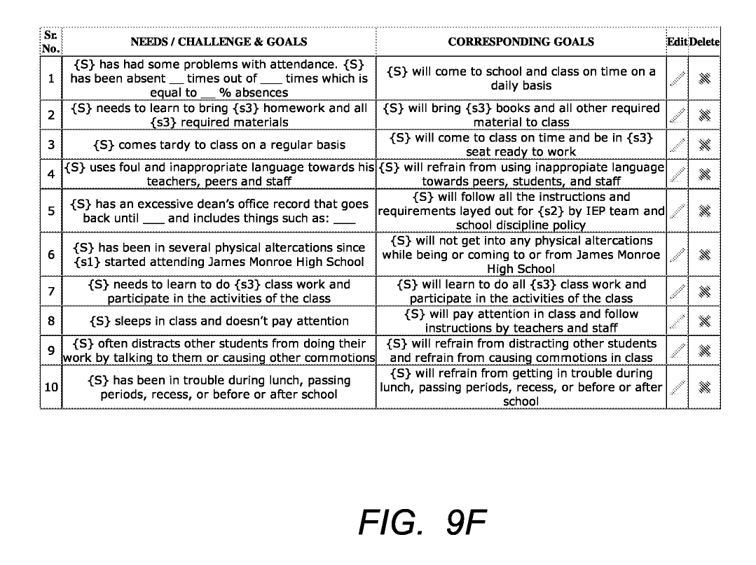

Once the information has been saved to the electronic database, the user is directed to a needs/challenges & goals summary page 86 as shown in FIGS. 9A-9F, which is similar in layout as the strengths summary page 64. Here, the user has the ability to edit and/or delete needs/challenges & goals (522). The information input into the system as part of step (520) is reproduced in a chart 88 organized again by subject matter (e.g., Geometry, Algebra, Reading, Writing, English Language Development (ELD), and Behavior). Specifically, the chart 88 includes a needs/challenges & goals number column 90, a needs/challenges & goals column 92, a corresponding goals column 94, and comparable edit and delete columns 96, 98, respectively. Preferably, this chart 88 is also organized first by the order subjects are entered in step (512), followed by the sequential entry of each need/challenge added as part of step (520). Likewise, a person of ordinary skill in the art will recognize that the information in the chart 88 could be organized and sorted by virtually any criteria. As shown in FIGS. 9A-9F, the system displays a list of needs/challenges & goals entered into the needs/challenges & goals input field 80 and the corresponding goals input field 82 as part of step (520) and reproduces those saved entries into the organized chart 88. The user may edit the needs\challenges & goals as part of step (522) in a process similar to that described above for the add needs/challenges & goals page 78 as part of step (520). Additionally, a needs/challenges and goals and the corresponding goals may be deleted by selecting the corresponding icon in the delete column 98.

The next step in accordance with the systems and methods disclosed herein is to add teacher monitoring in accordance with step (524). The user accesses an add teacher assessment monitoring page 100 by selecting the corresponding “add” link in a bubble associated with the teacher assessment monitoring tab 18 (FIG. 2). Here, page 100 displays two fields that include a title input field 102 and a subgroup input field 104. This area allows for the input of teacher assessments used to evaluate students. For example, titles entered into the title input field 102 may include “Work Samples” or “Teacher Interview”. The subgroup input field 104 allows users to further specify the assessment, such as “Work samples (Homework)”. Information is saved into the electronic database, as described above, by selecting a save button 106.

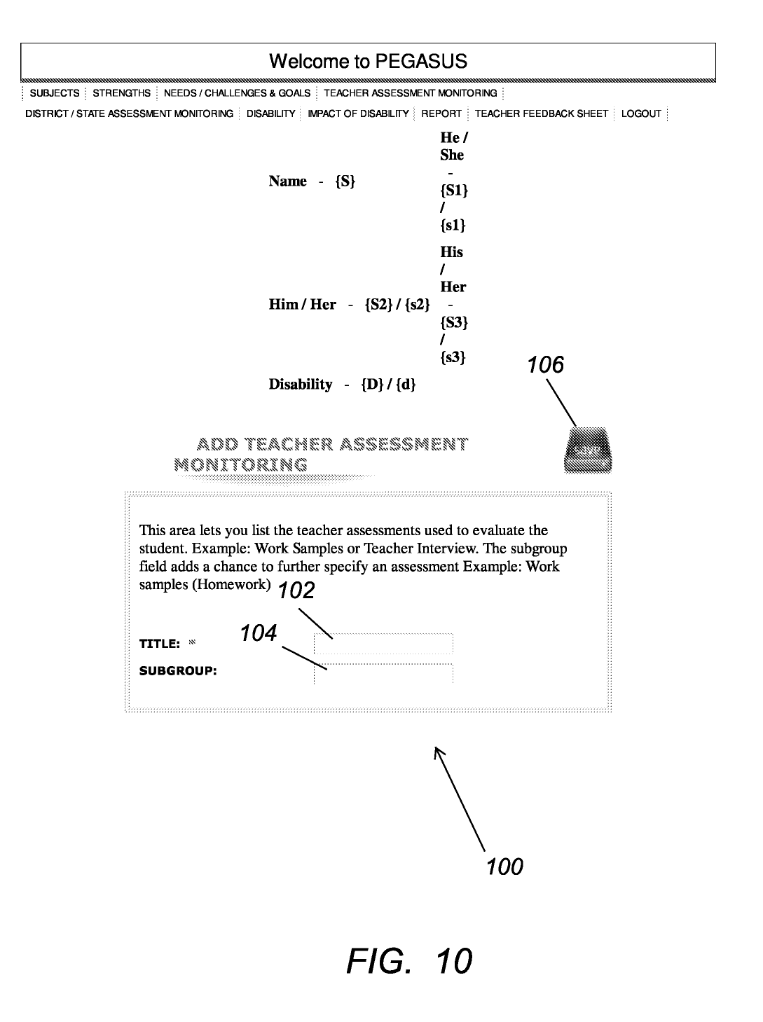

Once the information is saved as part of step (524), users are directed to a teacher monitoring summary page 108 as part of a step for editing or deleting teaching monitor titles and/or subgroups (526). Similar to the above, the information entered and saved as part of step (524) is organized into a chart 110 that includes a title number column 112, a title column 114, a subgroup column 116, and respective edit and delete columns 118, 120. The chart 110 is preferably organized by the entry of the title as identified by the title number column 112, but persons of ordinary skill in the art will readily recognize that other mechanisms may be employed to sort the chart 110, such as by alphabetical listing of the titles in column 114. A title and corresponding subgroup may be edited by selecting the respective icon in the edit column 118. As described above with respect to the strengths and needs/challenges and goals options, users are directed back to the add teacher assessment monitoring page 100 shown in FIG. 10 with the title input field 102 and the subgroup input field 104 pre-populated with the information to be edited. Saving the information in accordance with step (524) by selecting the save button 106 takes the user back to the teacher monitoring summary page 108 with the updated title and subgroup reflected in the chart 110. Additionally, a title and corresponding subgroup may be deleted by selecting the corresponding icon in the delete column 120.

Similarly, a user may add district/state assessments (528) by selecting the corresponding “add” link from a bubble associated with the district/state assessment monitoring tab 20 at the top of FIG. 2. Here, users are taken to an add district/state assessment monitoring page 122, which includes a title input field 124 and a subgroup input field 126. Users are able to input certain state or district assessments used to evaluate students into the input field 124, such as “California High School Exit Exam” or “Reading Counts”. The subgroup input field 126 allows the user to further specify details regarding the assessment. In the above example, one might enter the following into filed 126: “California High School Exit Exam (Mathematics)” to specify that the exit exam pertains to mathematics. Information entered in the fields 124, 126 is then saved into the computer database by selecting the save button 128.

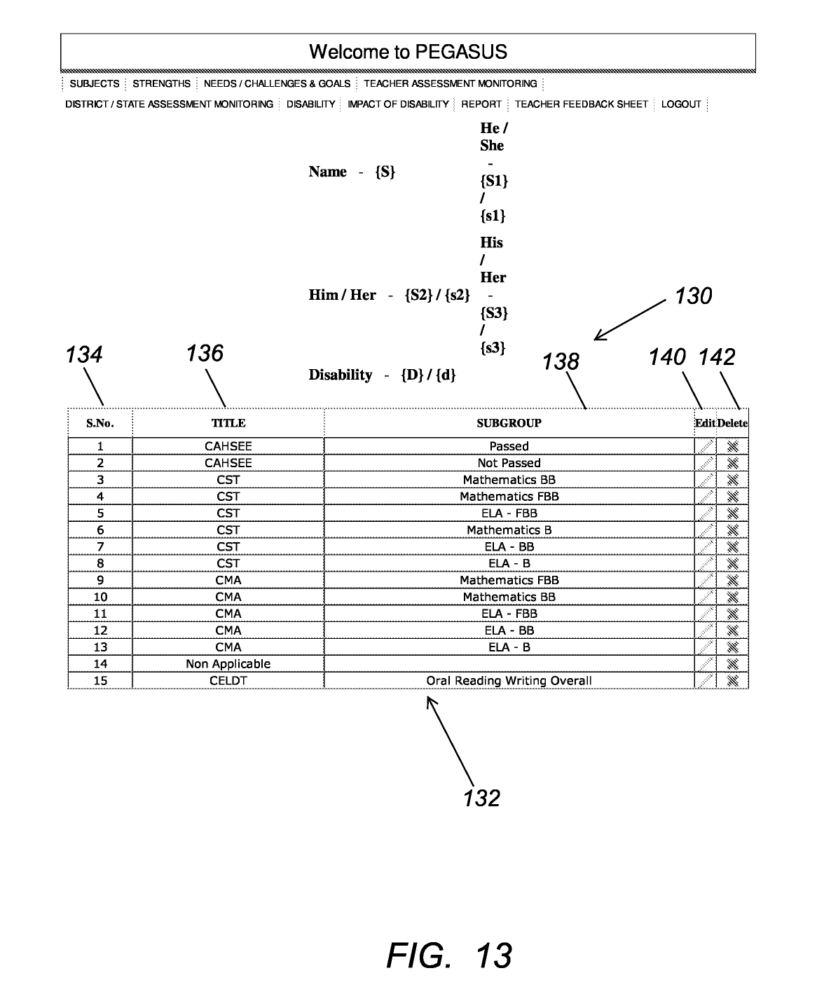

Once the information is saved as part of step (528), users are directed to a district/state assessment monitoring summary page 130, as shown in FIG. 13, for editing district/state assessments (530). Here, users can edit or delete the information entered into fields 124, 126 and saved to the common electronic database as part of step (528). This process is substantially similar to the step for editing and deleting teacher monitoring, as described above with respect to step (526). Specifically, information is organized into a chart 132 that includes a title number column 134, a title column 136, a subgroup column 138, and respective edit and delete columns 138, 140. The chart 132 is preferably organized by the entry of the title as identified by the title number column 134, but persons of ordinary skill in the art will readily recognize that other mechanisms may be employed to sort the chart 132, such as by alphabetical listing of the titles in column 136. To this end, editing the title and subgroup of an assessment is accomplished by selecting the corresponding icon in the edit column 140. This takes the user back to the district/state assessment monitoring page 122 with the input field 124 and the subgroup input field 126 pre-populated with the title and subgroup previously entered. Here, the user makes any requisite changes and saves the information by selecting the save button 128 as previously described with respect to step (528). The user is then taken back to the district/state assessment monitoring summary page 130 shown in FIG. 13. The user may also delete related titles and subgroups by selecting the corresponding icon in the delete column 142.

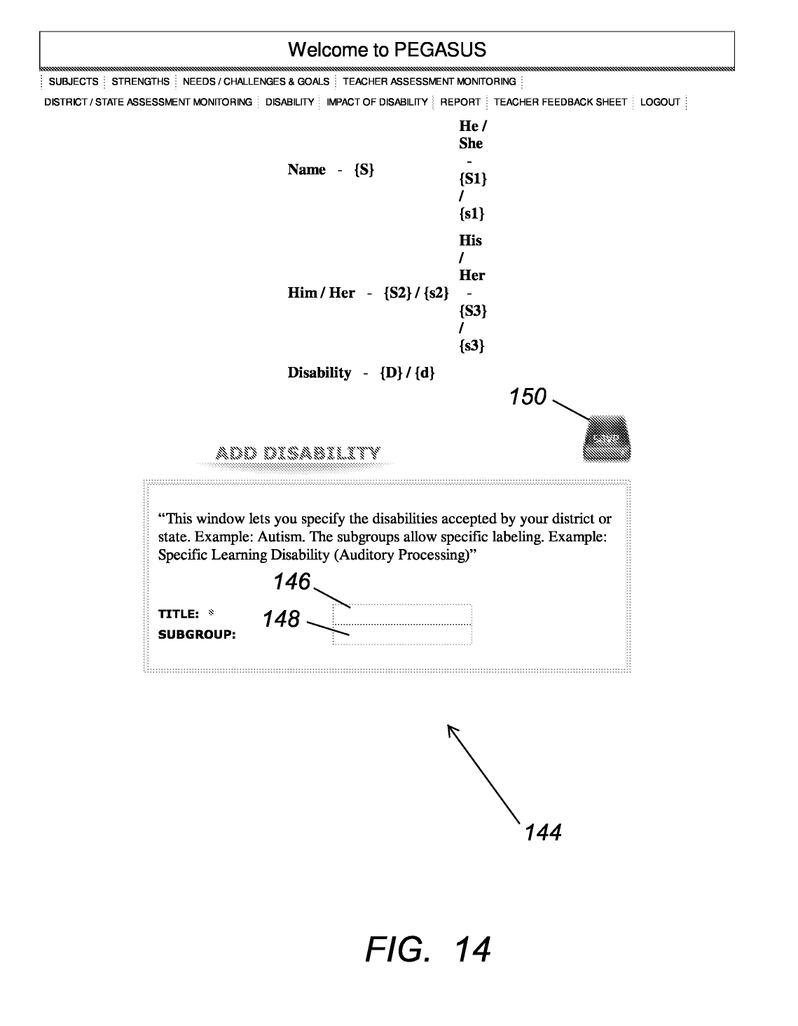

FIG. 14 illustrates an add disability page 144 for use in association with the step for adding disabilities (532), as shown in FIG. 1. Users arrive at this page by selecting the corresponding “add” link in the bubble associated with the disability tab 22 (FIG. 2). Here, users add or create new disabilities by typing information into a title input field 146 and a subgroup input field 148. For example, a user may enter “Autism” into the title input field 146, and more specifically identify that disability as “Specific Learning Disability (Auditory Processing)” in the subgroup input field 148. Information is saved by selecting the save button 150, in accordance with the embodiments described above.

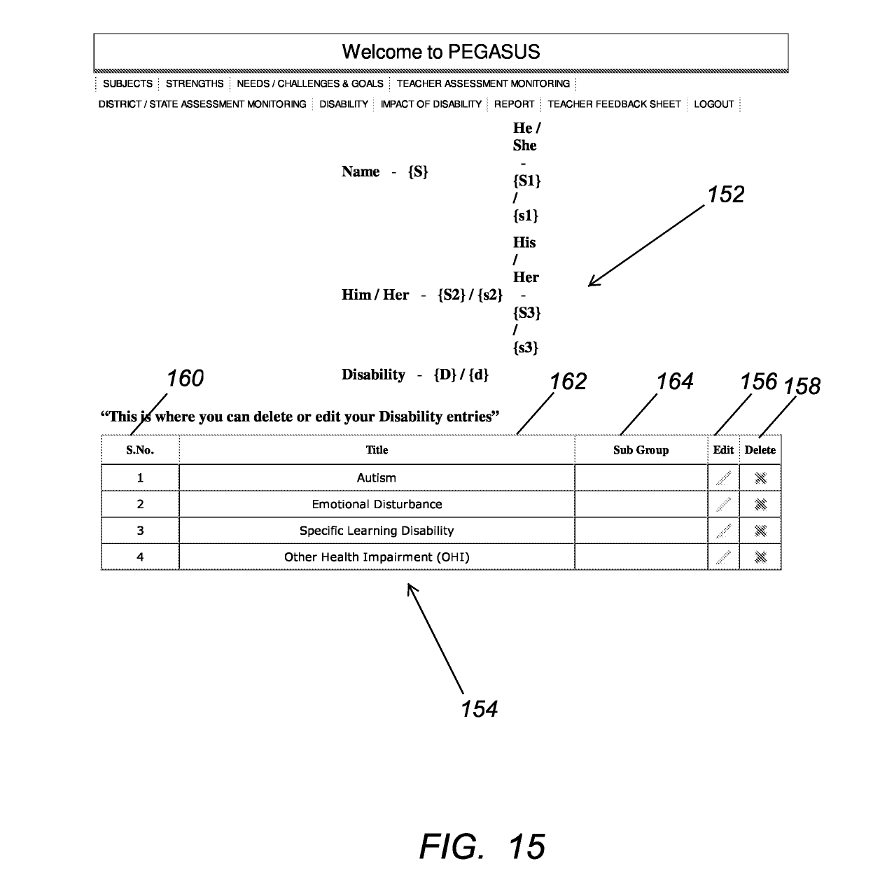

As with the other embodiments, the user is then directed to a disability summary page 152, as shown in FIG. 15. This page 152 similarly includes a chart 154 that organizes the data entered into the electronic database as part of step (532). Here, users have the ability to edit or delete the disabilities (534), such as through selection of the related icons in the respective edit column 156 or the delete column 158. The disabilities are preferably initially organized by entry number by a title number column 160, as shown in FIG. 15. Although, the chart 154 may be sorted in alphabetical order by a title column 162 or a subgroup column 164.

To edit a disability, the user selects the icon in the edit column 156 corresponding to the disability and sub group designed to be changed. Doing so takes the user back to the add disability page 144 shown in FIG. 14 with the disability and sub group pre-populated in the title input field 146 and/or the subgroup input field 148. From here, the user is able to edit and save the information in the fields 146, 148 in accordance with embodiment described with respect to step (532). Once saved, the user is taken back to the disability summary page 152 shown in FIG. 15. As with the above, deleting a disability and sub group is accomplished by selecting the corresponding icon in the delete column 158.

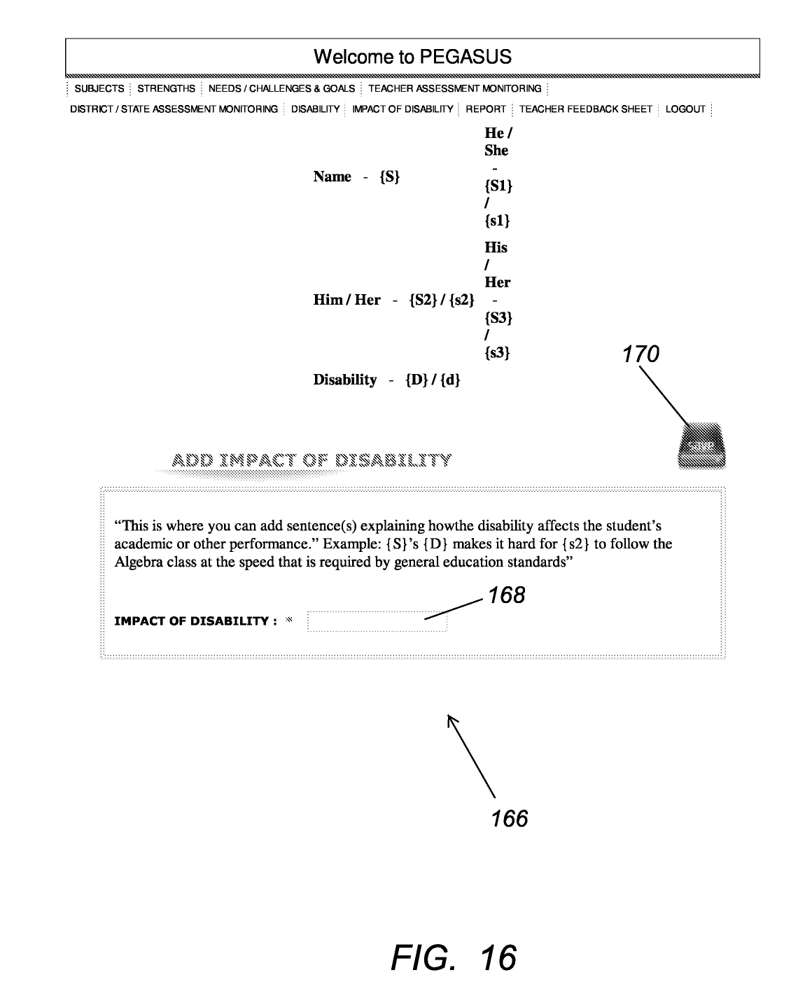

The last of the tab options described above with respect to adding or editing information per step (504) is the impact of disability tab 24. Here, selecting the “add” link from the bubble associated with this tab 24 takes users to an add impact of disability page 166, as shown in FIG. 16, where users can add an impact of disability (536). In an impact of disability input field 168, users enter sentences explaining how the disability affects student academic performance. For example, assuming student “Joe” has the disability of “Autism”, entry of “{S}'s {D} makes it hard for {s2} to follow the Algebra class at the speed that is required by general education standards” into the impact of disability input field 168 translates to “Joe's Autism makes it hard for him to follow the Algebra class at the speed that is required by general education standards” when reports are generated. Report generation using this information is shown in more detail below. The data from input field 168 is likewise saved in the computer database by selecting the save button 170.

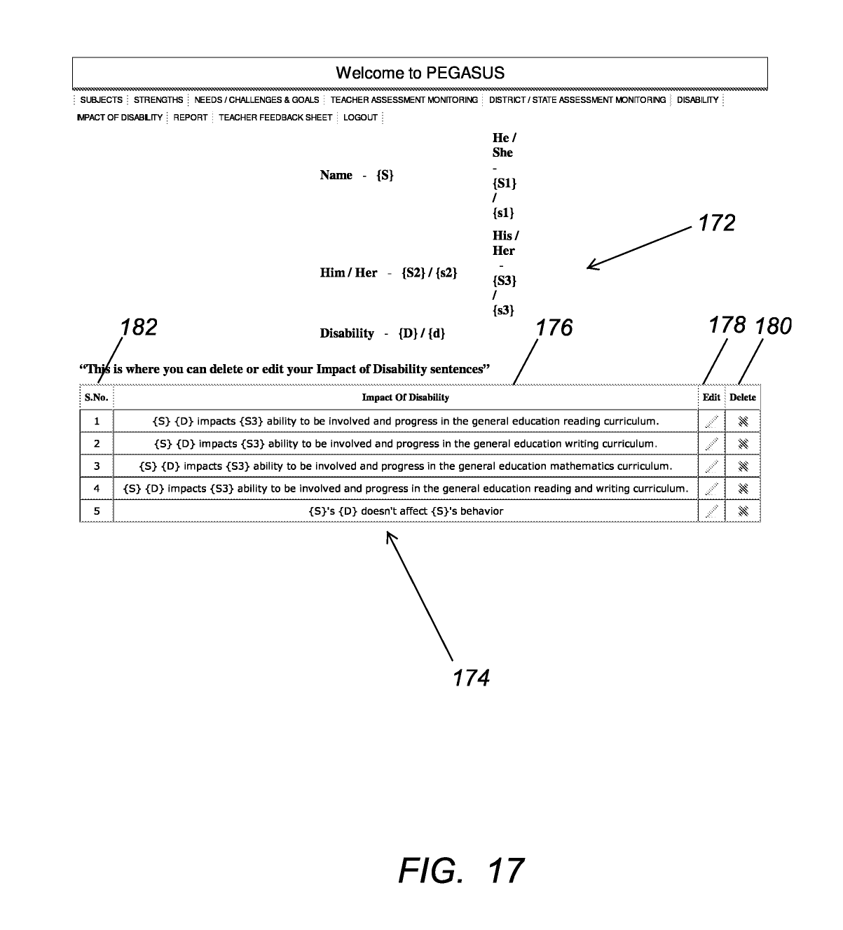

The system then takes the user to an impact of disability summary page 172 to edit and/or delete the impacts of disability in accordance with step (538). FIG. 17 illustrates another chart 174 displaying a list of previously created impacts of disability in an impact of disability column 176. The user may edit or delete impacts of disability (538) by selecting one of the respective icons in an edit column 178 or a delete column 180. Similar to the embodiments described above, the disabilities are preferably organized by order of entry in a title number column 182, but may be organized by other methods known in the art.

To edit an impact of disability, the user selects the corresponding icon in the edit column 178. This takes the user back to the add impact of disability page 166 as shown in FIG. 16 with the selected impact of disability pre-populated in the impact of disability input field 168. The user may then make any desired changes to the impact of disability before saving the information to the electronic database in the same manner described above with respect to step (536) by selecting the save button 170. Next, the user is taken back to the impact of disability summary page 172 for editing in accordance with step (538). As described with respect to the other embodiments above, deleting an impact of disability is accomplished by selecting the corresponding icon in the delete column 180.

The information added or entered as part of steps (512), (516), (520), (524), (528), (532), and (536) is preferably initially entered in the sequence described above. When the requisite data has been added or entered in accordance with these steps, an authorized user later accessing the system may simply decide to edit and/or delete information, thereby bypassing the aforementioned adding steps (512), (516), (520), (524), (528), (532), and (536), by selecting the respective “view” links presented in each bubble associated with respective tabs 12-24 (FIG. 2). Thus, as shown in FIG. 1, it is possible to access the edit/deleting steps (514), (518), (522), (526), (530), (534), and (538) directly, without first performing corresponding adding steps (512), (516), (520), (524), (528), (532), and (536).

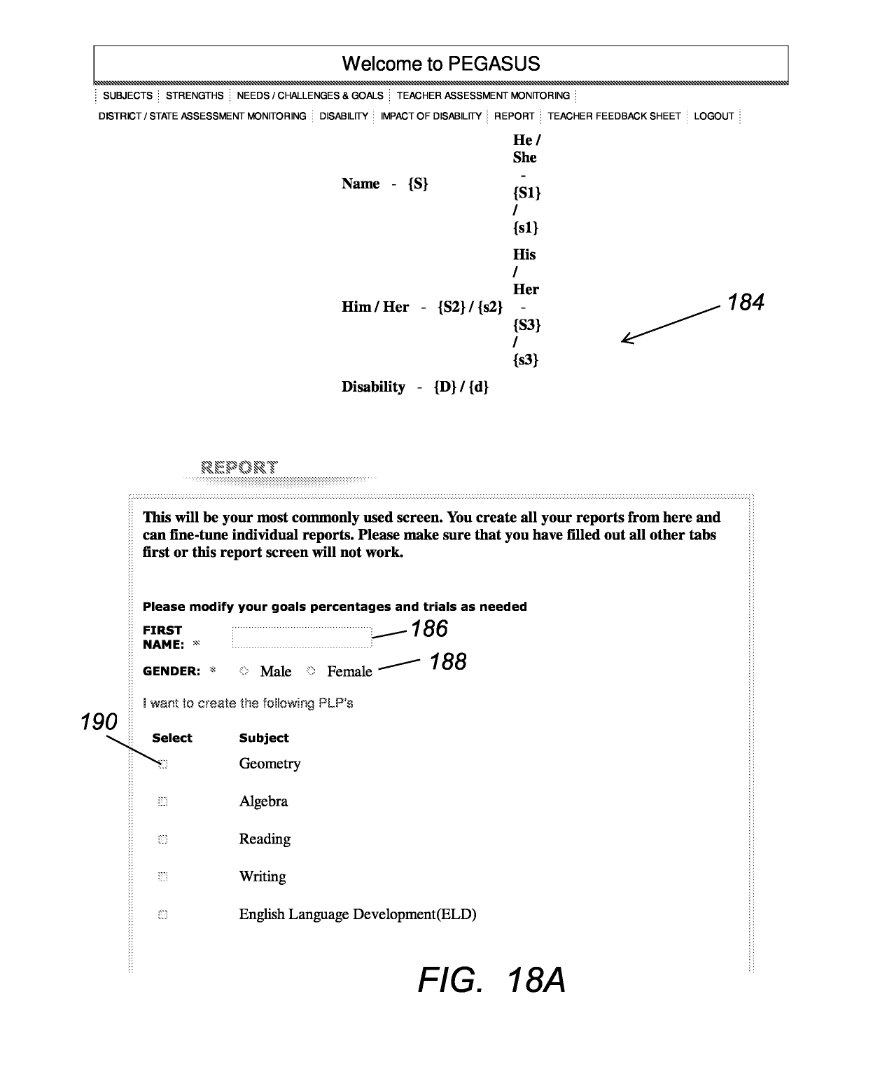

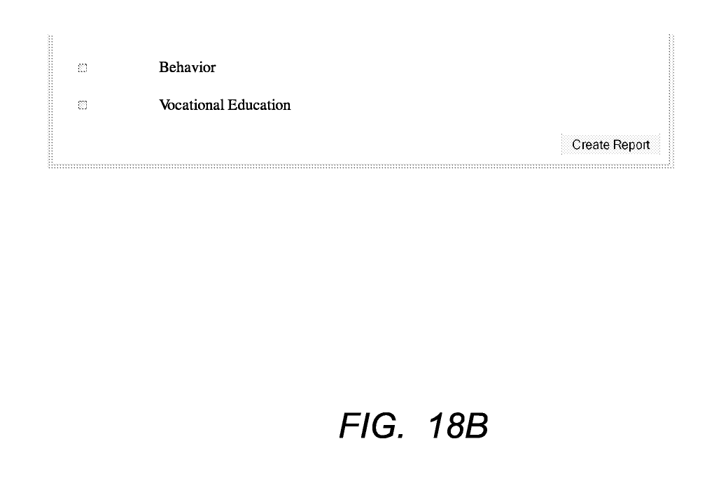

Once the user has entered the required data as part of the steps for adding subjects (512), adding strengths (516), adding need/challenges & goals (520), adding teacher assessment monitoring (524), adding district/state assessment monitoring (528), adding disability (532), and adding impact of disability (536), the user is now able to prepare a report in accordance with step (506). The first part of step (506) involves clicking on the report tab 26, as shown in FIG. 2. The system redirects the user to a report generation page 184, as shown in FIGS. 18A-18B. Here, the user enters a student name (540) into a student name input field 186 and selects a radio button 188 corresponding to the student gender (542). The user then selectively checks the boxes corresponding to each subject to be included in the report (544). For example, the user may select a geometry checkbox 190 so that the subject “Geometry” is included in the final report.

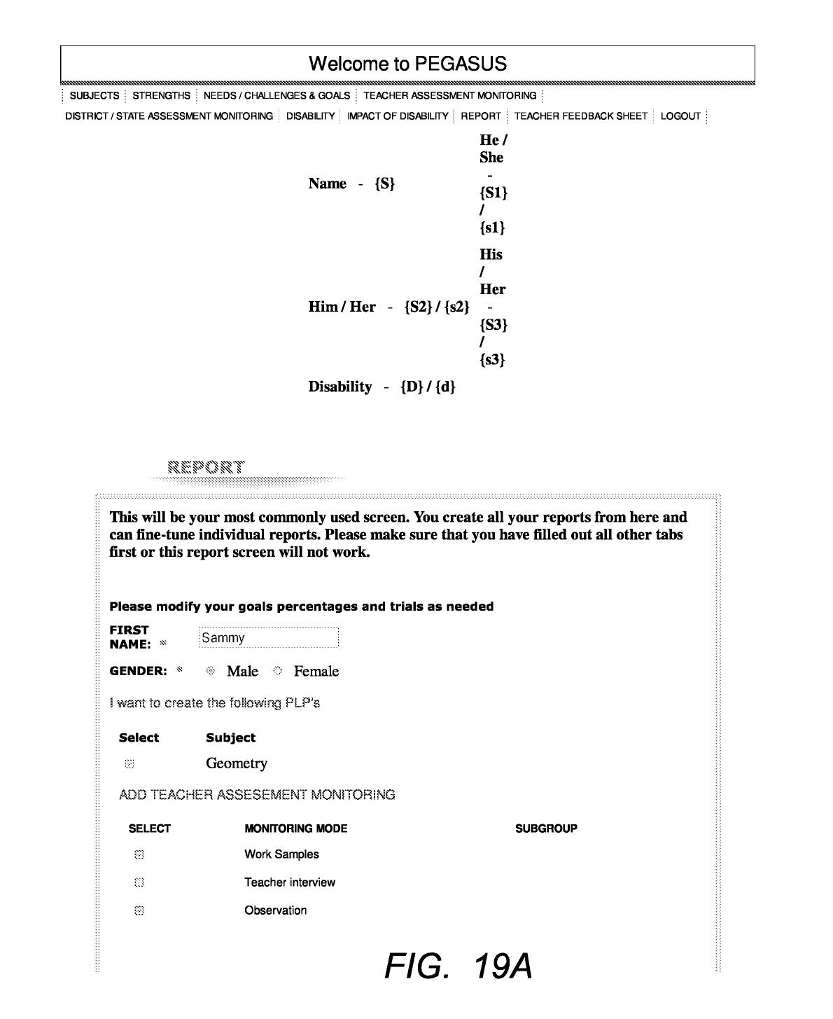

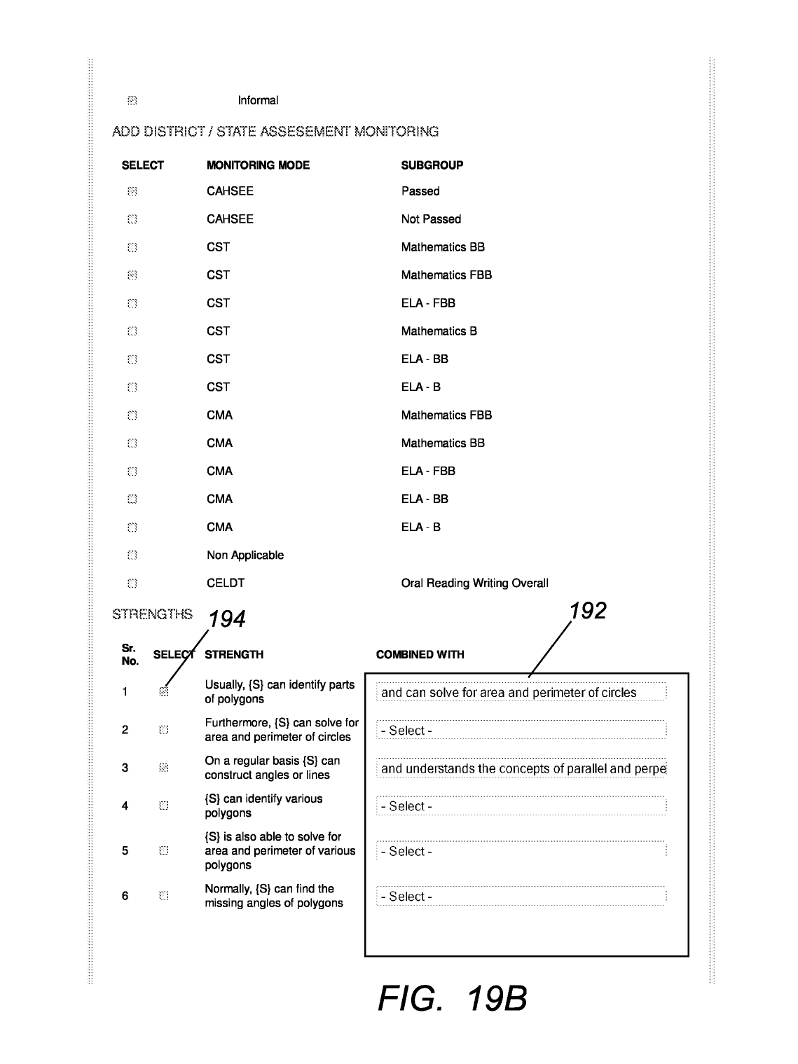

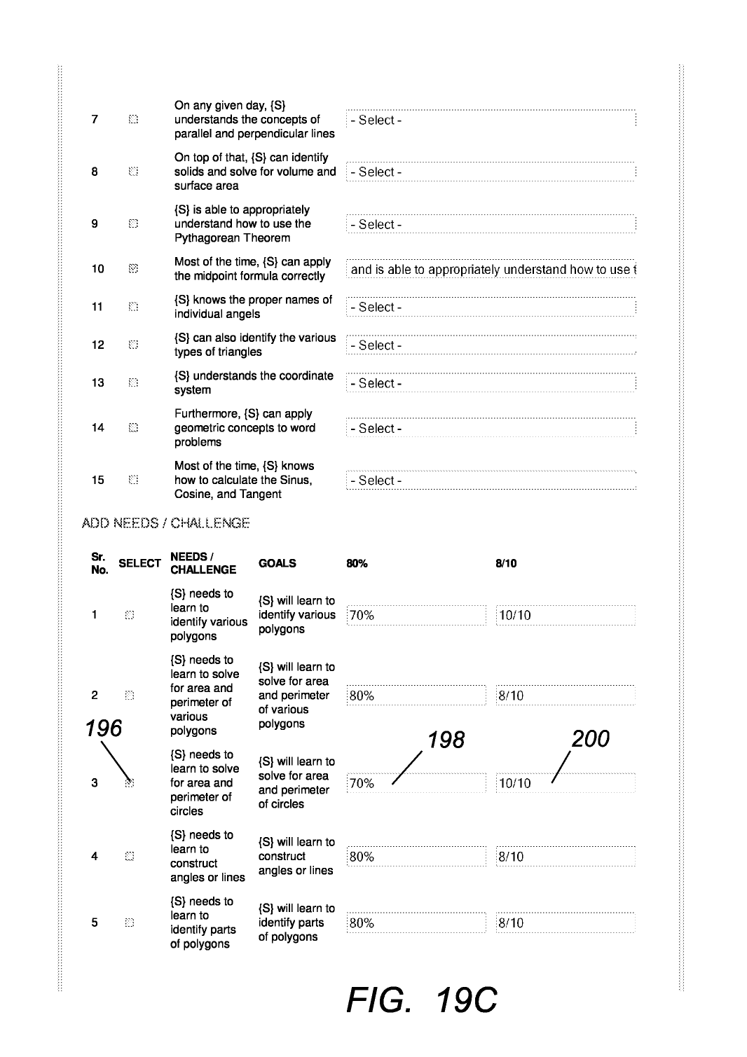

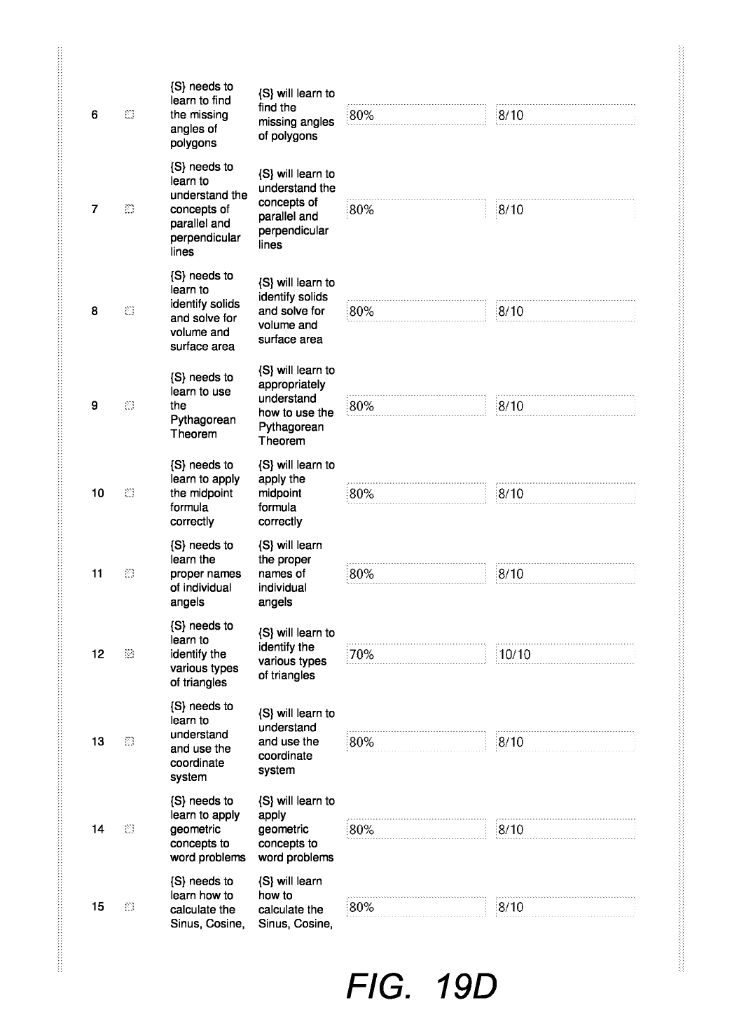

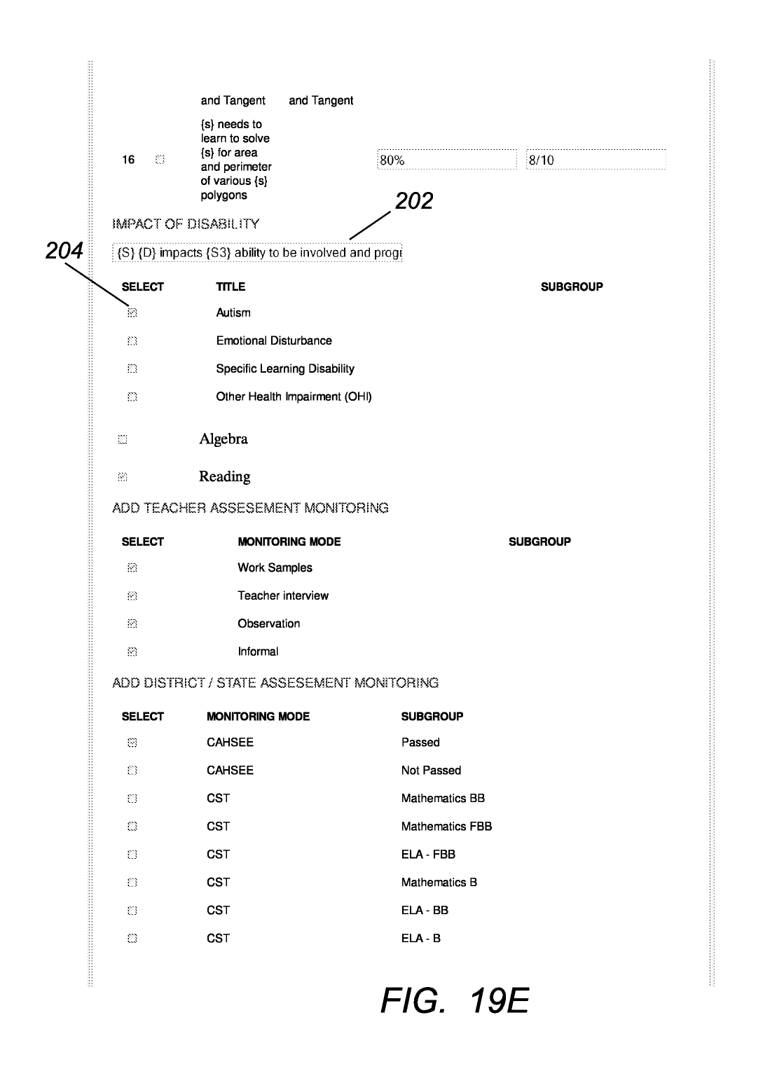

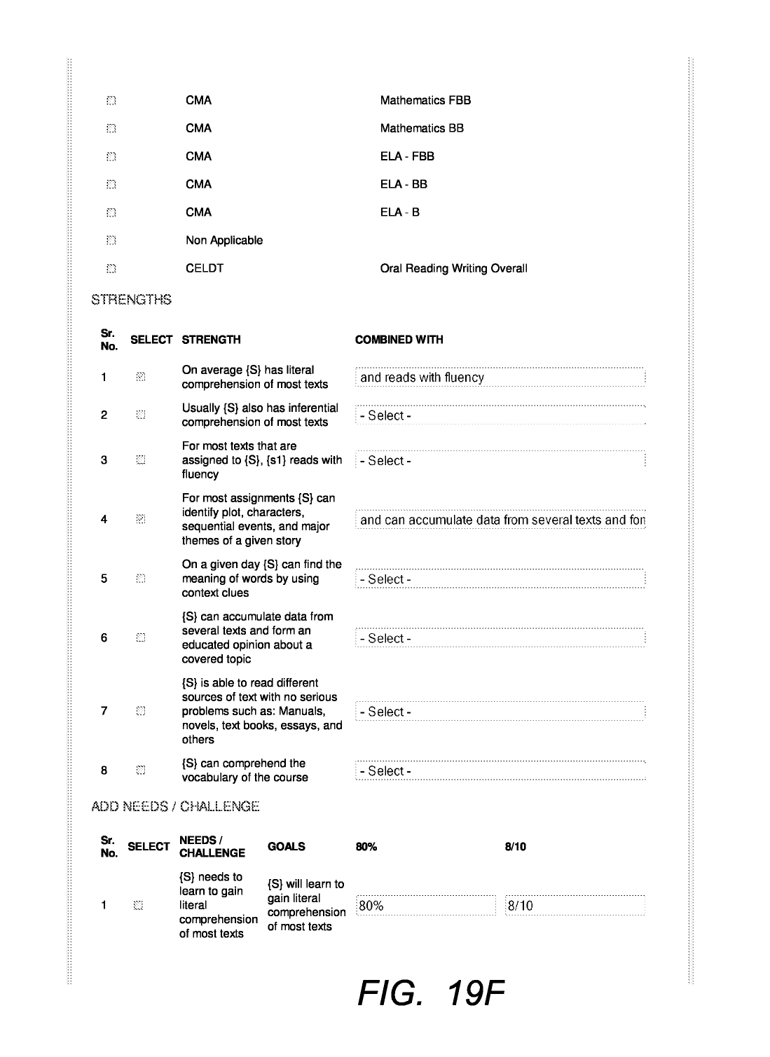

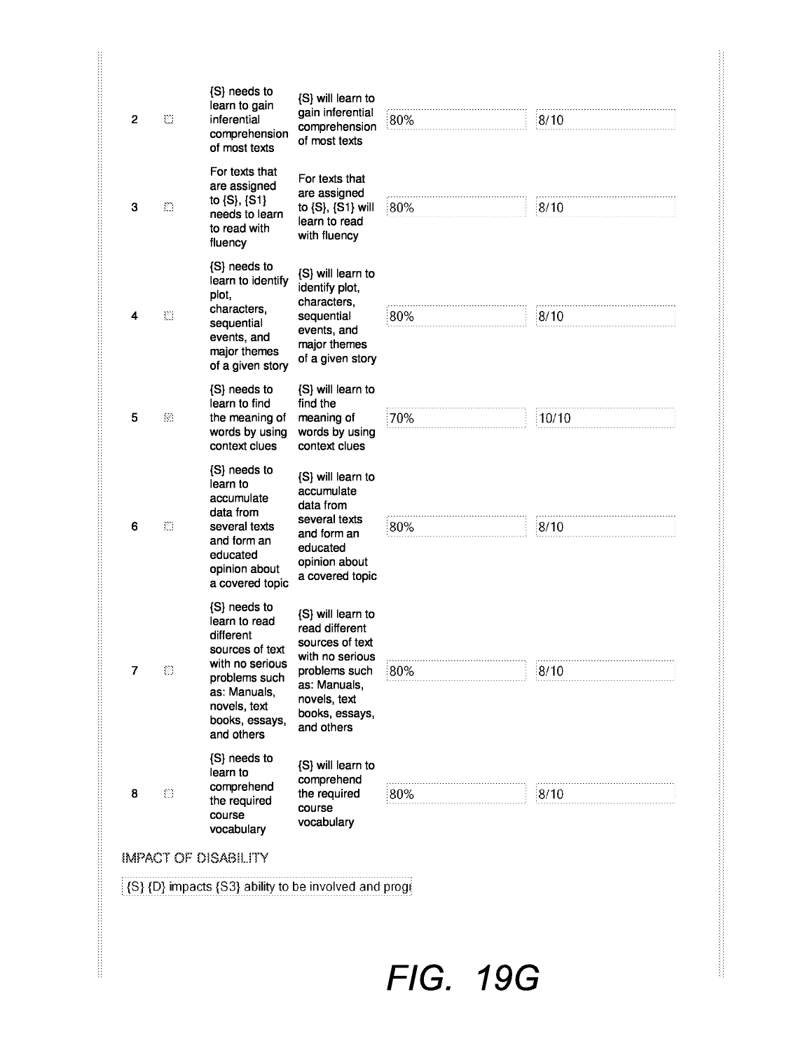

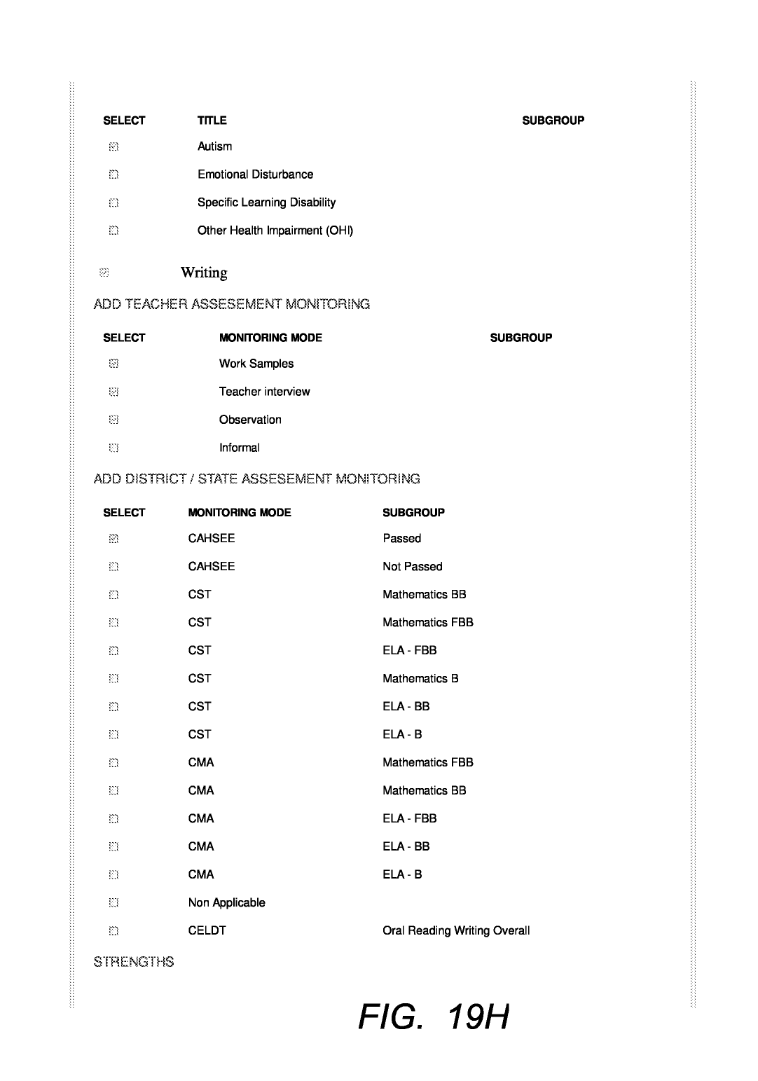

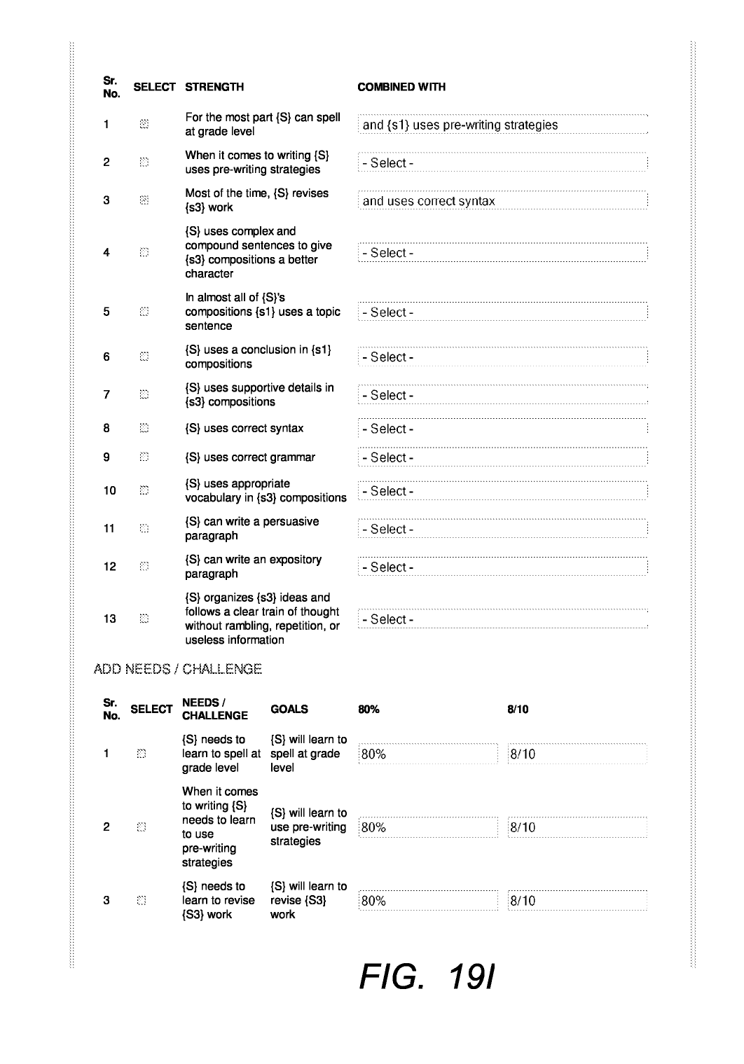

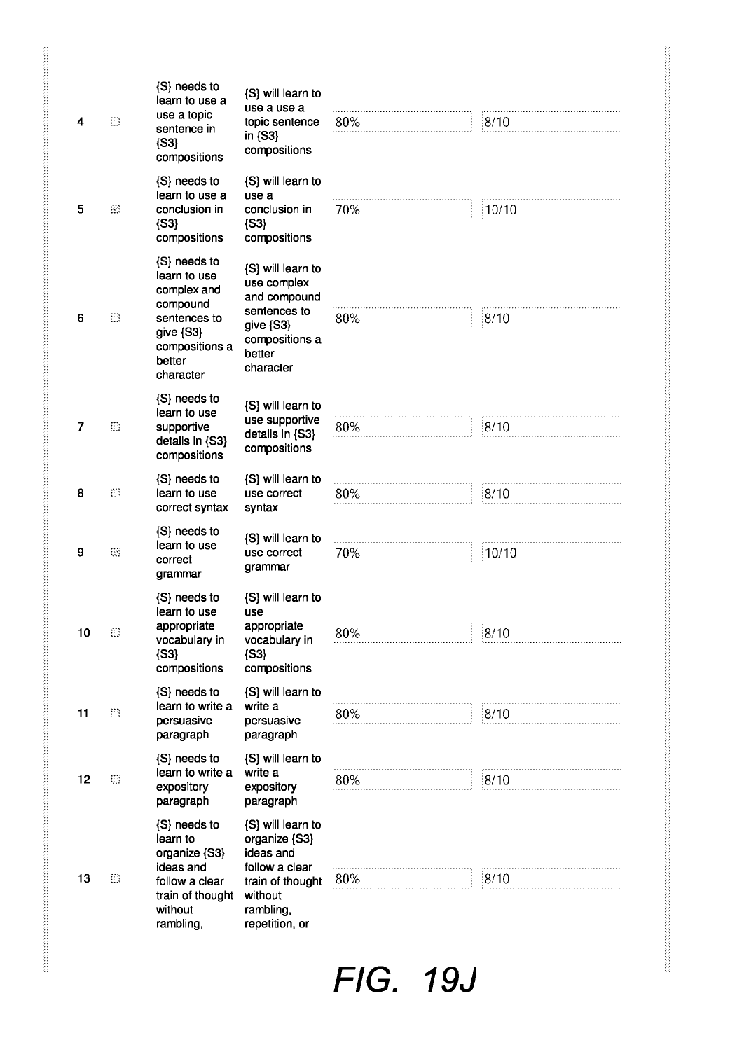

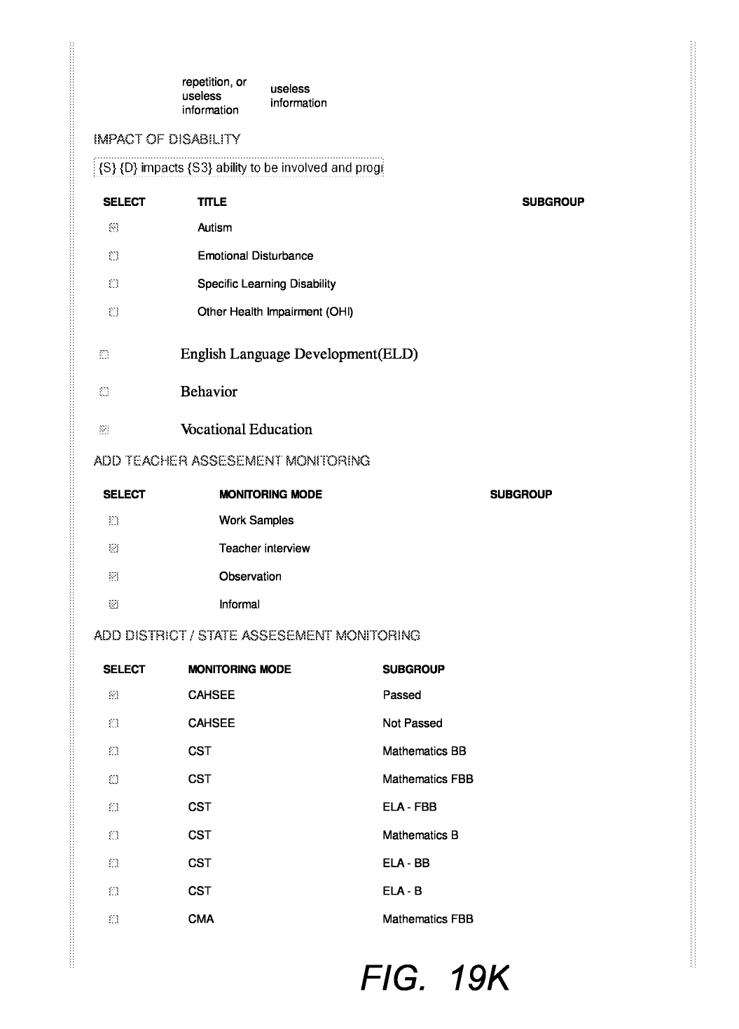

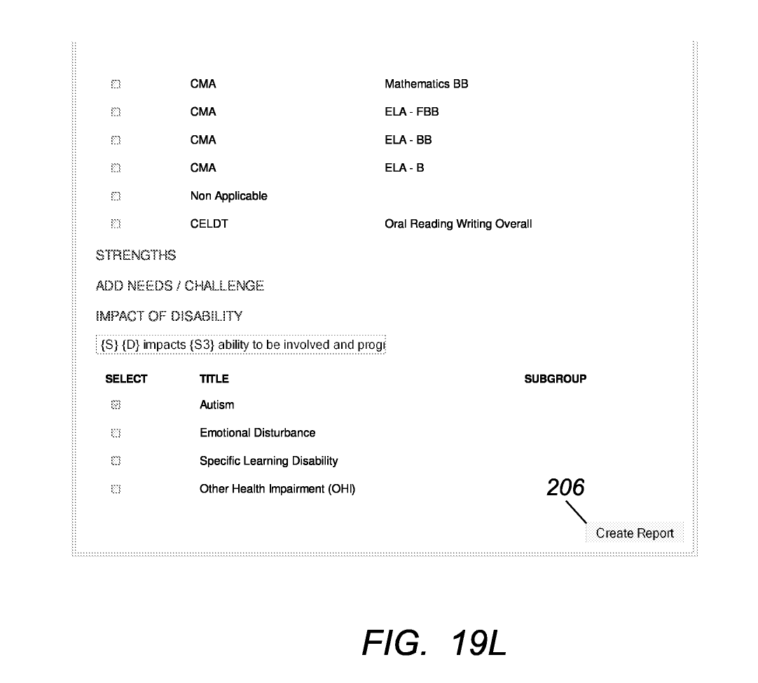

Once the geometry check box 190 has been selected, the system retrieves data previously entered for this subject for selected inclusion in the report. In this respect, FIGS. 19A-19L illustrate a series of options that can be selectively included in the final report under the “Geometry” subject. To prepare the report, the user may check one or more of the boxes corresponding to the appropriate teacher assessment methods (546), such as the criteria shown in FIGS. 19A-19B under the Add Teacher Assessment Monitoring (FIG. 19A) and Add District/State Assessment Monitoring section headings (FIG. 19B). Under the Strengths section heading as shown in FIG. 19B, the user next checks the appropriate boxes and selects the corresponding combined part from the adjacent drop down box for inclusion in the report as part of the step for selecting strengths (548). In one example shown in FIG. 19B, the user selected “Usually, {S} can identify parts of polygons” as the strength, and “and can solve for area and perimeter of circles” as the combined part from a drop-down box 192 by selecting a check box 194. The user should check each of the strengths applicable to the assessment. Likewise, the user checks the applicable boxes under the Add Needs/Challenge section heading (FIG. 19C) and inputs the percent accuracy of the goal and the fraction of trials in the corresponding input fields as part of a step for selecting the needs/challenges (550). For example, in FIG. 19C, the third Needs/Challenges & Goals option has been selected at check box 196 and a 70% accuracy was entered into an input field 198 along with a 10/10 trial fraction being entered into an input field 200. The user proceeds to fill the applicable input fields under the Add Needs/Challenge section heading as shown through the rest of FIG. 19C and FIGS. 19D-19E. The next step in report generation is for the user to select the appropriate impact of disability (552) from a dropdown box 202 under the

Impact of Disability heading as shown in FIG. 19E. An example selection is shown in box 202 in FIG. 19E that includes the phrase “{S} {D} impacts {S3} ability to be involved and . . . . ” In terms of report generation, if the Autism disability is selected as shown by checking check box 204, the corresponding sentence would read “Sammy's Autism impacts his ability to be involved and . . . . ”

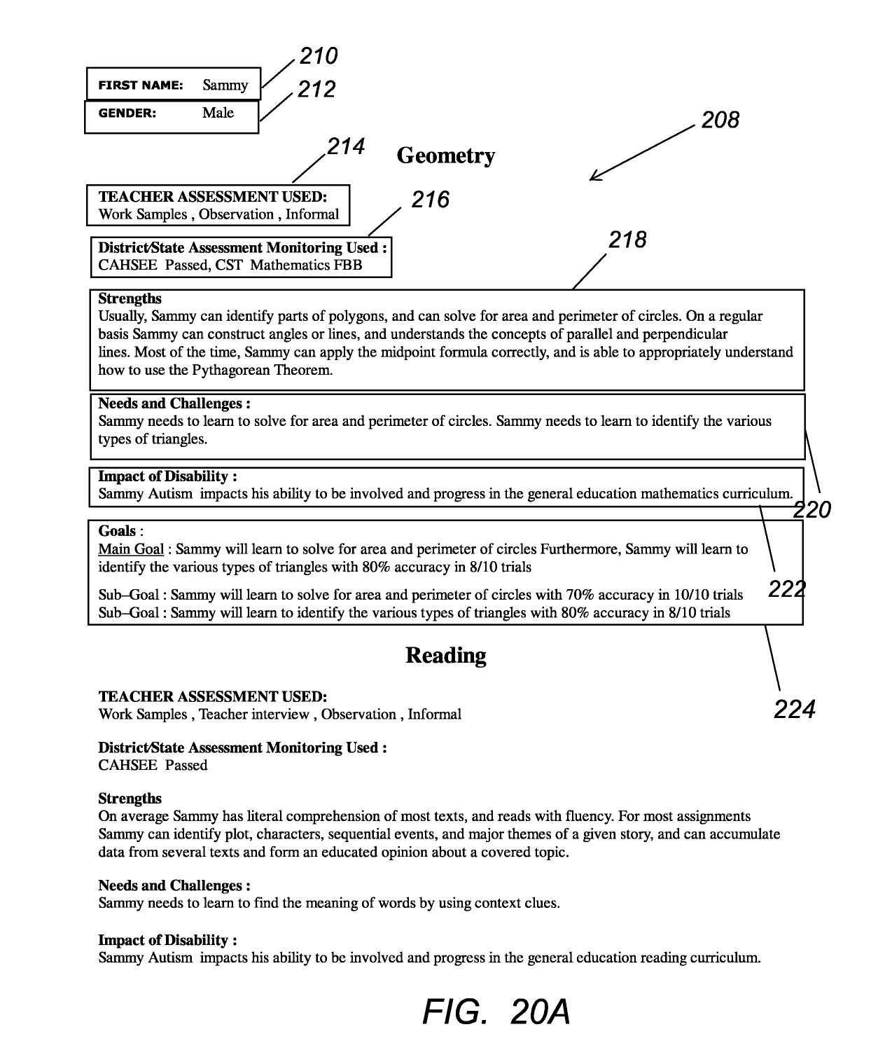

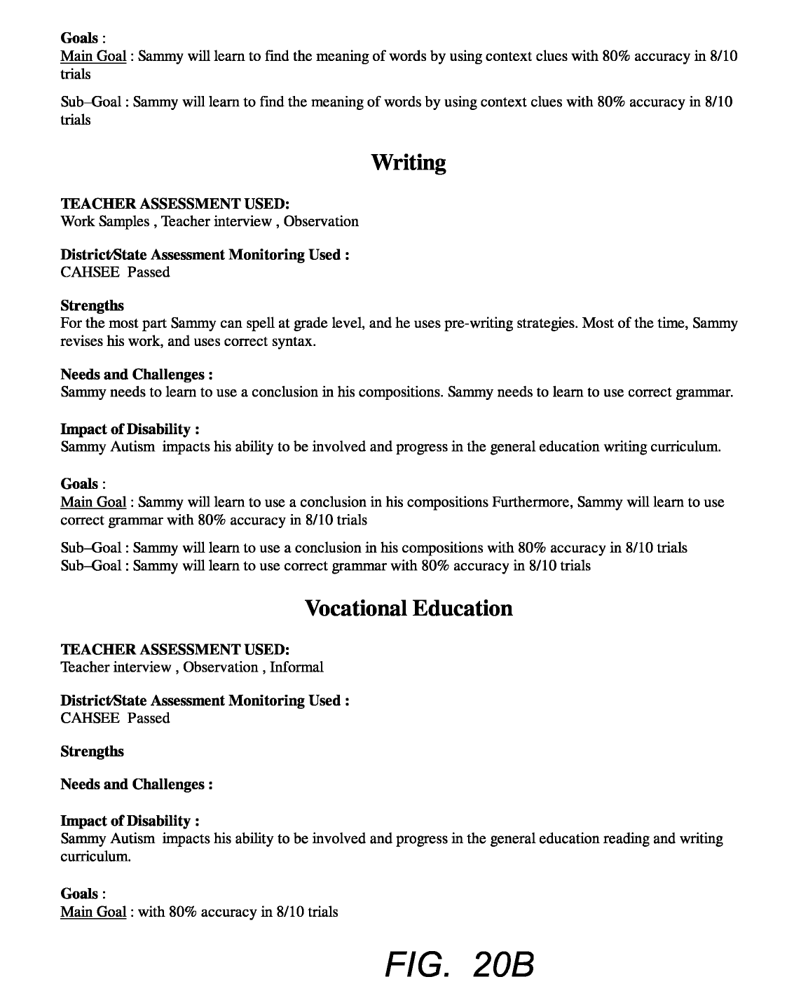

The user then determines whether to add another subject (554). Here, if the user endeavors to add another subject, the user repeats the steps related to selecting the subject (544), selecting teaching assessment methods (546), selecting strengths (548), selecting needs/challenges (550) and selecting impact of disability (552), as described above. In the example shown in FIGS. 19A-19L, the user repeats steps (544)-(552) for the “Writing” and “Vocational Education” subjects so that the report generates information for all of the “Reading”, “Writing” and “Vocational Education” subjects, as shown in FIGS. 20A-20B. Once the appropriate selections have been made, the user generates a report (556) by selecting a create report button 206, as shown in FIG. 19L.

Next, the system generates a student report 208, as specifically shown with respect to FIGS. 20A-20B, as part of a report generation step (556). Here, the system retrieves data previously input and stored into the common electronic database during steps (540)-(552) for output into a neat and organized complete PLP and goals report 208. For example, the name entered into the student name input field 186 repopulates into the area generally identified by box 210. Similarly, the gender selected by radio button 188 populates in the area generally identified by box 212. In this respect, the system populates data in the remainder of the report 208 as follows: box 214 lists the items selected under the Add Teacher Assessment Monitoring section heading as shown in FIGS. 19A-19B. In this example, the “Work Samples”, “Observation” and “Informal” boxes were checked and now appear in the area designated by box 214. Box 216 includes the items checked under the Add District/State Assessment Monitoring heading shown in FIG. 19B. Here, the monitoring modes selected in FIG. 19B include “CAHEE Passed” and “CST Mathematics FBB”, which are represented in this box 216. Furthermore, Box 218 corresponds to the information entered under the Strengths heading in FIGS. 19B-19C. For example, box 218 states that “Usually, Sammy can identify parts of polygons and can solve for area and perimeter of circles.” This information shows up in the report 208 in the area identified by box 218 because the user marked checkbox 194 corresponding with this strength. The next strength (Sr. No. 3 shown in FIG. 19B) starts the next sentence as shown in FIG. 20A.

One can quickly understand how the systems and methods described herein more efficiently create standardized reports. In this respect, boxes 220, 222, 224 include the information respectively entered as part of the information entered under the Add Needs/Challenge section heading shown in FIGS. 19C-19E, the Impact of Disability heading shown in FIG. 19E, and the Goals section heading shown in FIG. 19F. The step for generating the report (556) populates respective information for each subject, which includes “Reading”, “Writing” and “Vocational Education” in this example.

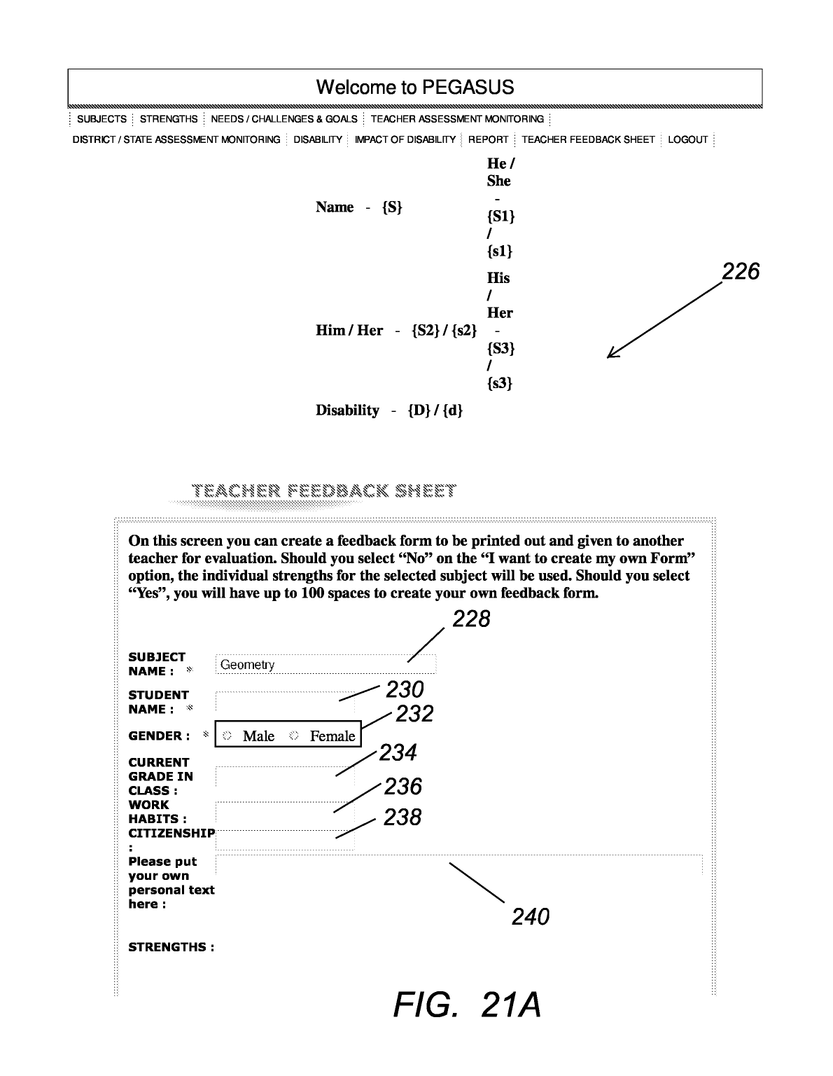

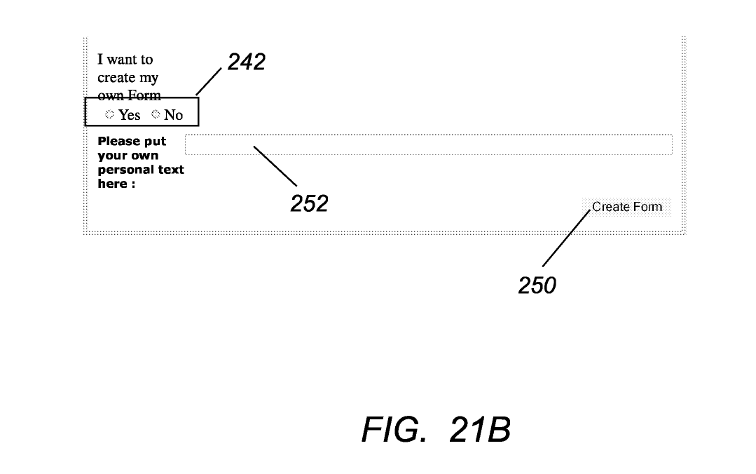

Finally, the user has the option to prepare an optional teacher feedback sheet in accordance with step (508). Here, the user selects the teacher feedback sheet tab 28 (FIG. 2) to be taken to a teacher feedback sheet page 226, as shown with respect to FIGS. 21A-21B. This page 226 allows the teacher to create a feedback form to be printed out and given to another teacher for evaluation. In this respect, the first step is to select the subject (558). In a preferred embodiment, each subject entered into the system as part of step (512) is available for selection from the dropdown box 228. Next, the user enters a student name (560) into a name input field 230 and selects a gender (562) by clicking one of the appropriate radio buttons identified in area 232. The user continues to enter the student's current grade (564) into a class grade input field 228, enter work habits (566) into a work habits input field 236, enter the student's citizenship (568) into a citizenship input field 238, and enter personalized text (570) into a personal information input field 240.

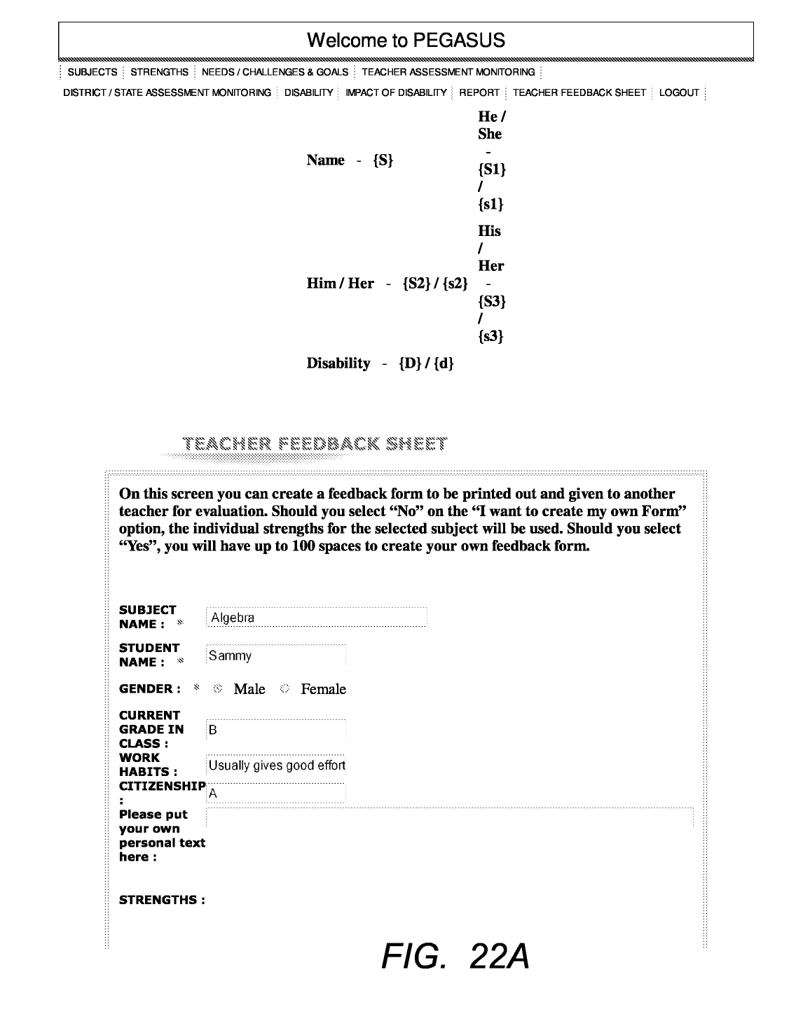

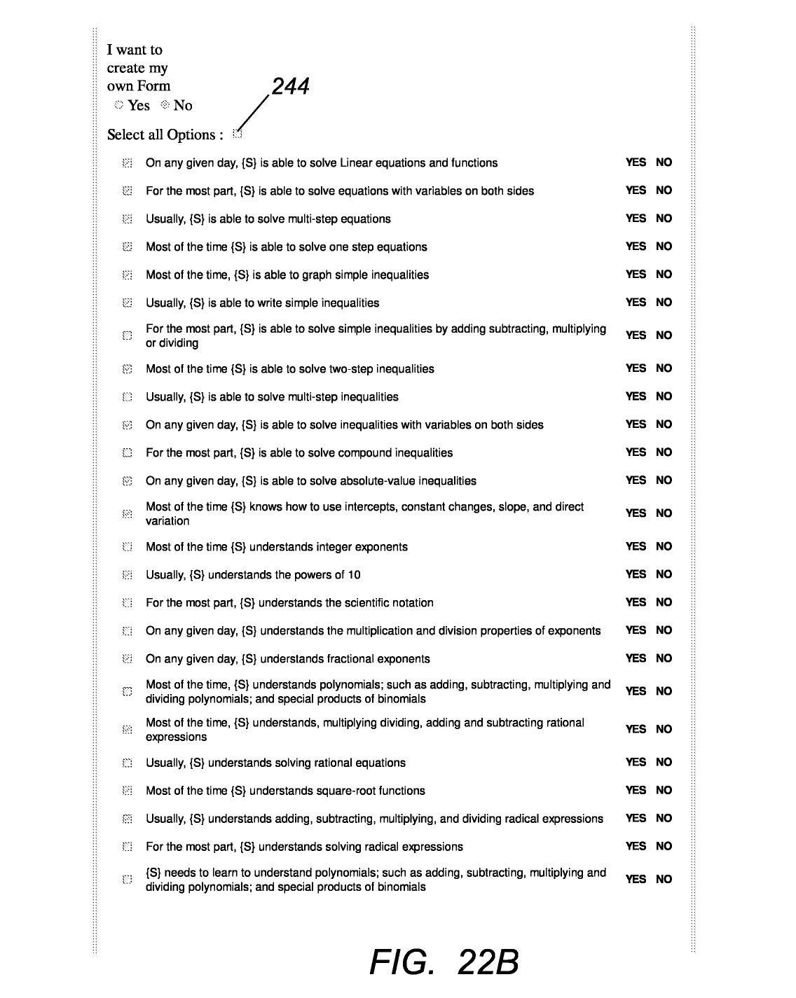

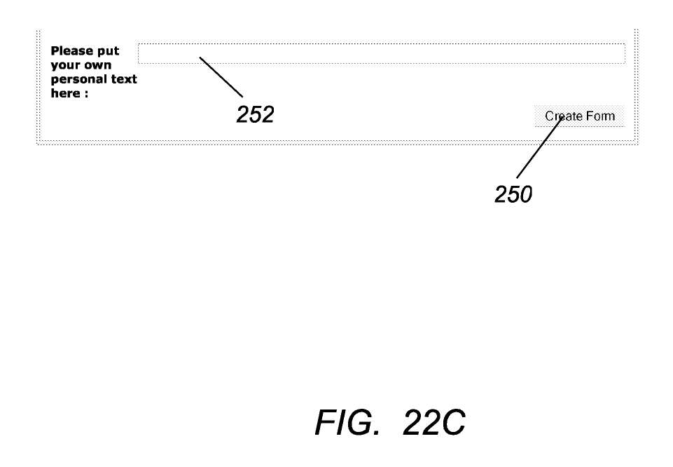

Next, the user must decide whether to create a new form or utilize an existing form for creating the report during decision step (572). This is accomplished by selecting the appropriate radio button identified generally in area 242 in FIG. 21B. In this respect, before the report is created, the user can select whether to create an entirely user entered form for observing strengths or select a system generated form. In the first embodiment wherein the user selects the “No” radio button as part of step (572) as shown in FIG. 21B, the system automatically retrieves strength data corresponding to the subject selected from the drop-down box 228 as part of step (558). This information is used to automatically populate and finalize the form. To complete the process, the user selects one or more of the strengths, for example those shown in FIG. 22B, for inclusion on the teacher feedback sheet by checking the appropriate boxes (574) next to the strength to be included in the report. FIG. 22B illustrates a plurality of these check boxes marked for inclusion in the report. The system may give the user the option to select all strength options by selecting a check box 244.

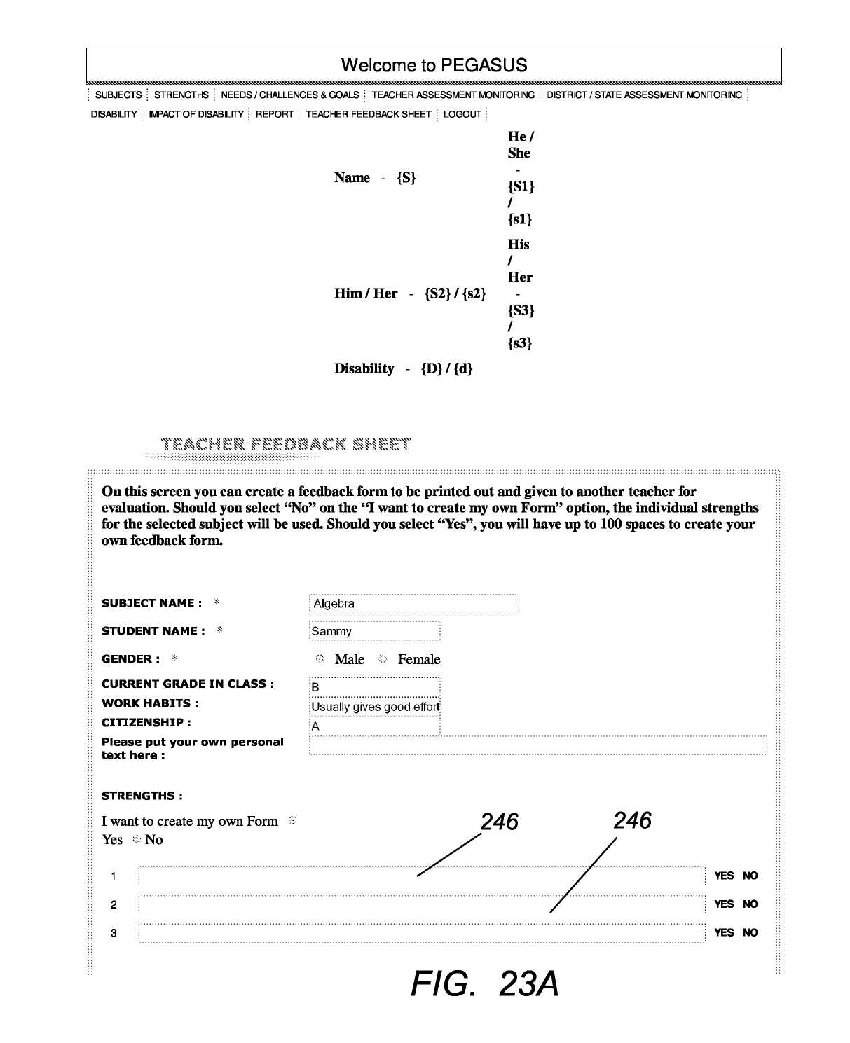

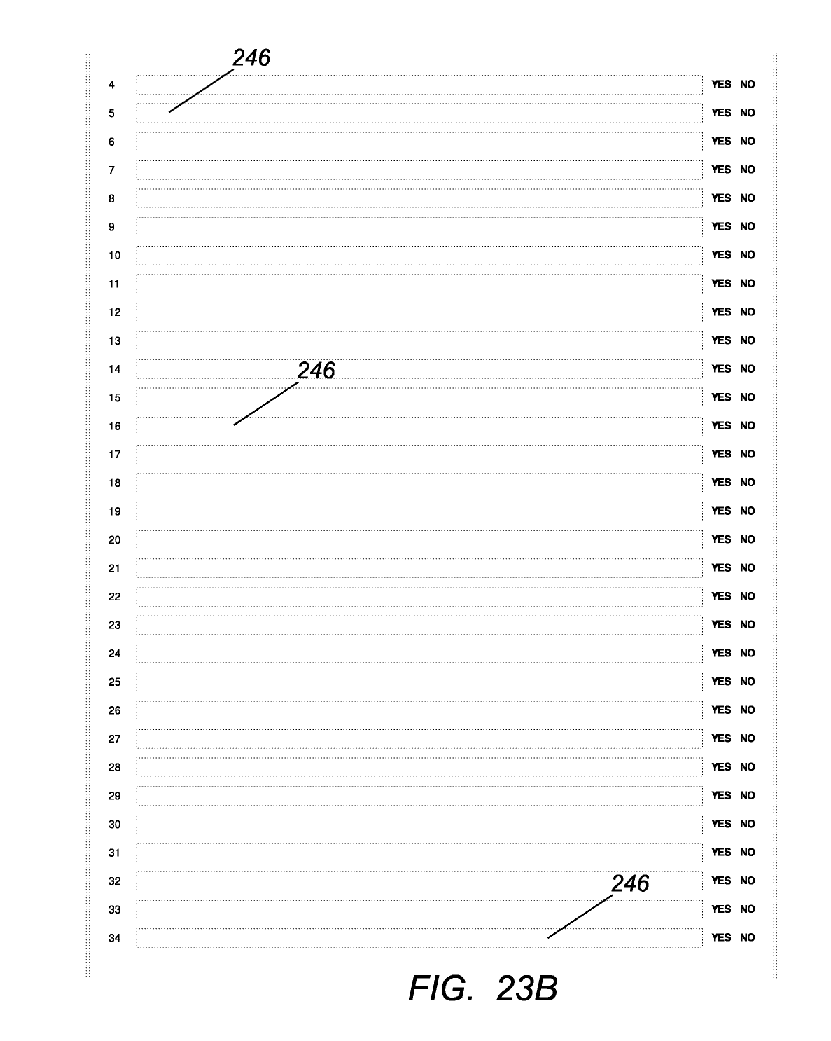

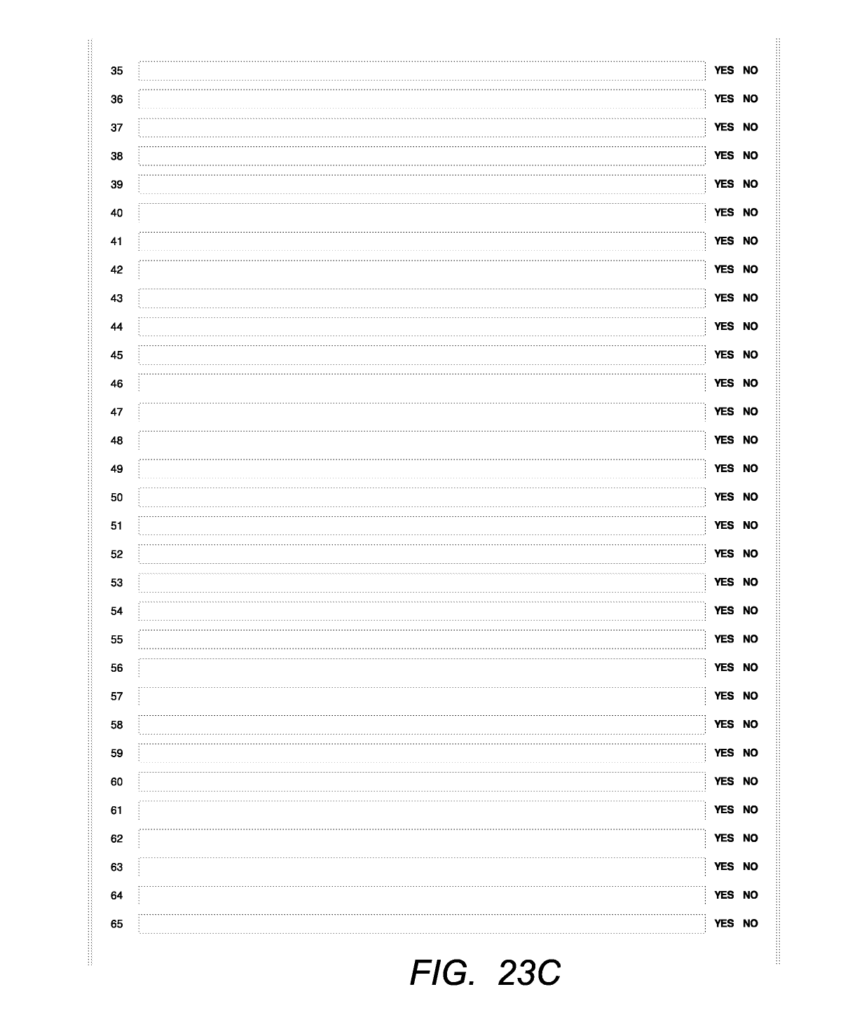

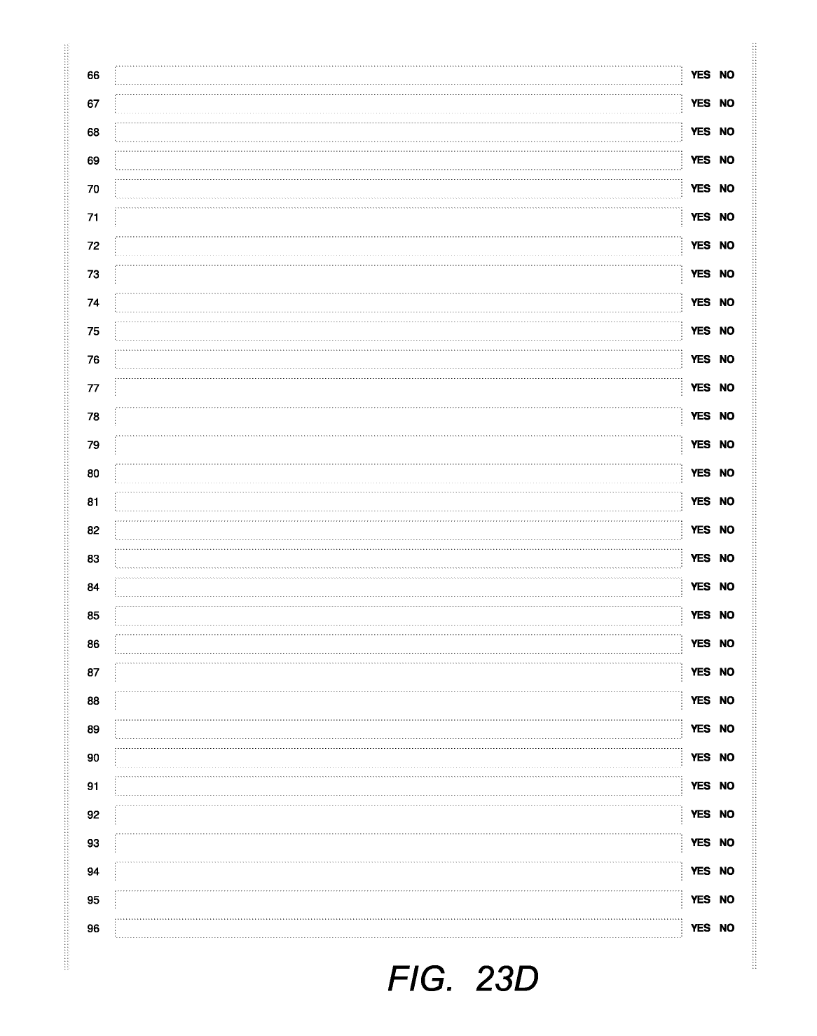

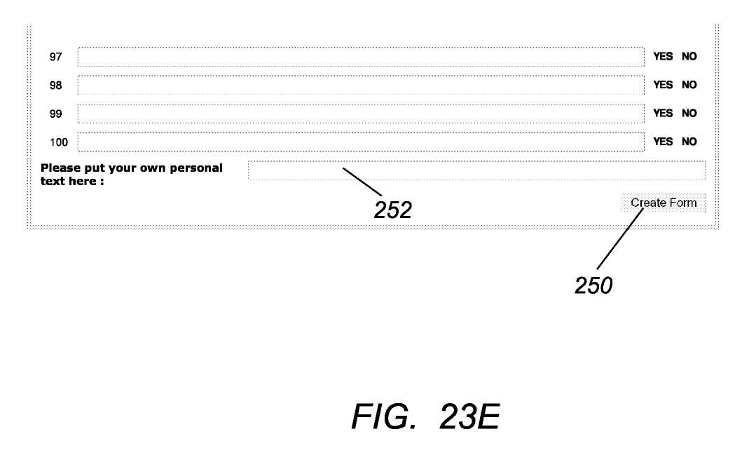

Alternatively, as shown with respect to FIGS. 23A-23E, if the user decides to select the “Yes” radio button in area 242 (FIG. 21B) during step (572), the system generates a plurality of input fields 246 (in this example 100) where the user may enter text (578) related to the strengths to be included in the report. After the user enters the data desired to be included in the final report, either through step (574) or steps (576)-(578), the user can initiate generation of the teacher feedback sheet (580) by clicking a create form button 250 (FIGS. 21B, 22C, 23E). The user may optionally add other comments into a text input field 252 before generating the report (580).

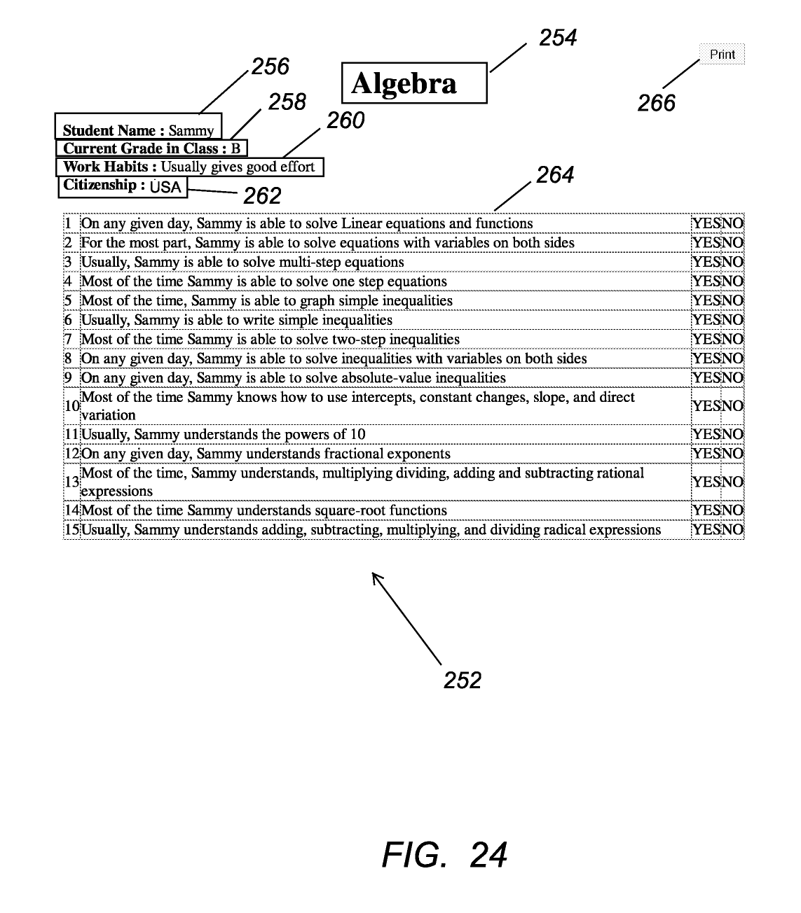

Upon selecting the create form button 250, the system proceeds to generate the teacher feedback sheet (580) for output in a teacher feedback page 252 shown in FIG. 24. Here, the system generates a report based on the data input as part of steps (558)-(578). As shown in FIG. 24, the subject selected from the drop-down box 228 as part of step (558) is generally shown in area 254 and may be utilized as a subject heading for the report. That is, the student reports may be individually created and organized by subject. This is particularly beneficial as the student may have different teachers that vary by subject. Further to generation (580), the teacher feedback page 252 also includes the student name entered into the name input field 230 as part of step (560) in area 256, the grade entered into the glass grade input field 234 as part of step (564) in area 258, the work habits entered into the work habits input field 236 as part of step (566) in area 260, and the citizenship (USA) entered into the citizenship input field 238 during step (568) in area 262. Finally, the teacher feedback page 252 lists the various strengths either automatically generated and selected by the user during step (574) or manually entered as part of steps (576)-(578) in an organized chart 264. This complete teacher feedback sheet 252 can be printed by selecting a print button 266 and used by an educator in the evaluation of a student.

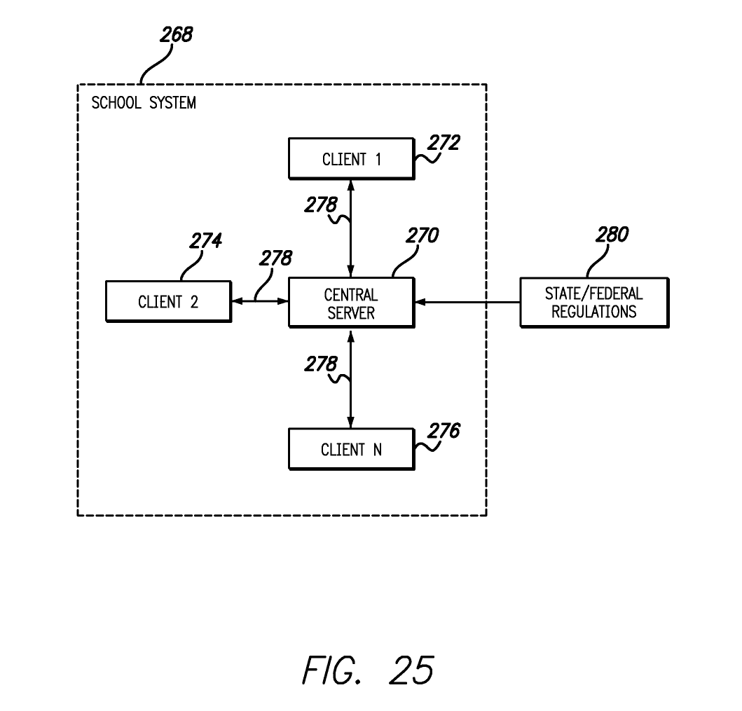

Lastly, FIG. 25 is a diagram illustrating the preferred communication avenues for using the systems and methods described above. In this respect, a school system communication network is generally identified by the dotted lines 268. In this embodiment, the school system has a central server 270 in bilateral communication with a first client 272, a second client 274 or any one of a number of additional clients identified as “Client N” in box 276. As briefly mentioned above, each of the clients 272-276 may communicate with the central server 270 by means of any communication network 278 known in the art. One aspect of the communication network 278 is that the central server 270 is able to exchange information with each of the clients 272-276 in real time, such as presenting the aforementioned webpages, processing information entered into the various input fields, and using that information to formulate reports. For example, the first client 272 may be entering information into any one of the aforementioned input fields as part of the process for inputting data (504). Once the data is saved, it is immediately available to the second client 274 connecting to the central server 270 through the communication network 278. The central server 270 may run multi-user accessible database software such as FoxPro, IBM DB2, Linter, Microsoft Access, Microsoft SQL Server, MySQL, Oracle, PostgreSQL or SQLite. In this respect, the systems and methods disclosed herein maintain the standardization of the information used to generate the PLP reports and teacher feedback information in one or more databases simultaneously accessible by multiple users.

Furthermore, the central server 270 is preferably in communication with a computer hosting the state and/or federal regulations 280. In this respect, as state or federal regulations regarding the processing and generation of PLP reports change, this external system 280 is preferably able to communicate directly with the school system's central server 270 to update the requirements for generating the aforementioned reports. For example, such an update might include adding or removing certain criteria required to be in the reports. This feature of the systems and methods disclosed herein virtually eliminates the need to retrain each teacher/school administrator responsible for creating the reports when laws change, and it ensures that each school system connected to this state/federal regulation host 280 remains compliant with state and/or federal laws regarding the evaluation and generation of PLP reports.

In another aspect, the systems and methods for streamlining data compilation and report generation may include a translator for translating information within the system (e.g., in a commonly accessed electronic database) from one language to another. As described above, users preferably access the system through a web-based platform from a client system (e.g., from one or more of the clients 272, 274, 276) to the central server 270. Due to potential language variations within the school system 268 (e.g., English and Spanish), information stored and retrieved from the central server 270 is preferably presentable to the end user in the desired language of choice. In this respect, the central server 270 may perform translations between, for example, English and Spanish (or vice versa), so that the end user can read the information in the choice language. Of course, a person of ordinary skill in the art will readily recognize that the translator may translate in and among many different languages, other than just English and Spanish (e.g., German, French, Italian, Russian, Japanese, Chinese, etc.). The user may be able to select the preferred language before logging in, e.g., at the welcome screen 10 (FIG. 1), or the user may have a language option as an account setting that allows the user to select the preferred language. Furthermore, language translation may occur at the central server 270 or by a third party translation system (e.g., the web-based Google Translator). Of course, all facets of the information within system can be translated, including the information shown through the web-based software system, information entered into form fields and saved or processed by the central server 270, and information retrieved from the state/federal regulators 280.

In one embodiment, the user may have the ability to translate information at the time it is entered into any of the above-mentioned input fields. For example, there may be a “+” with a drop-down menu next to the corresponding input field. Here, the user can select a desired translated language. Using the above-mentioned example from the adding strengths step (516), the “+” may appear next to the strengths input field 58 and/or the combined part input field 60 on the add strengths page 54 shown in FIG. 6. A user may first enter: “{S} can add up to number 10” into the strengths input field 58. The user would then select a language from a drop down menu by selecting the “+” and choosing the desired translated language. For instance, selecting “German” as a translated language would translate “{S} can add up to number 10” into “{S} kann bis zur Nummer 10 addieren”. These two sentences (both English & German) become associated with one another and stored together in the electronic database. Of course, this language association feature would be available for all input fields described herein. When the final student report is created, the user may select the desire language from a drop down box so the report is generated or printed in the desired language (e.g., English, German, Spanish, etc.). In the example above, both English and a German translation report would be available. Thus, the translator further ensures universal access and cross-language consistent use and report generation, in accordance with the embodiments disclosed herein.

Although several embodiments have been described in detail for purposes of illustration, various modifications may be made without departing from the scope and spirit of the invention. Accordingly, the invention is not to be limited, except as by the appended claims

What is claimed is:

1. A method for streamlining data compilation and report generation, comprising the steps of:
storing one or more academic categories having one or more performance indicators in an electronic database, each of said one or more performance indicators forming a part of a sentence;
associating one or more metrics with each of said one or more performance indicators in said electronic database, each of said one or more metrics forming another part of said sentence;
displaying said one or more academic categories, said one or more performance indicators and at least one metric associated therewith via an interactive computer medium;
receiving student information and selections of said one or more academic categories, said one or more performance indicators and said at least one metric from said interactive computer medium over a communication network; and
combining each of said received performance indicators with each of said received metrics and based on said student information into at least one complete sentence presentable in a student report measuring an academic performance of a student for said one or more academic categories.

2. The method of claim 1, including the step of printing said student report or presenting said student report to said interactive computer medium.

3. The method of claim 2, wherein said interactive computer medium comprises a computer monitor or a touch screen.

4. The method of claim 1, wherein said receiving step includes the step of receiving data communications from at least two remote devices via said communication network.

5. The method of claim 4, including the step of compiling said student report from said at least two remote devices simultaneously over said communication network.

6. The method of claim 5, wherein said compiling step includes the step of simultaneously adding, deleting, or modifying said student report from said at least two remote devices through respective interactive computer mediums.

7. The method of claim 1, wherein said performance indicator comprises an academic strength or an academic weakness and said metric comprises a grade including a percentage or a fractional score.

8. The method of claim 1, including the step of injecting a variable field into said sentence, said variable field fillable based on said student information when presented in said student report.

9. The method of claim 8, including the step of translating said student information into at least one gender-based pronoun usable in said complete sentence in said variable field.

10. The method of claim 1, including the step of establishing multiple connection requests in a central server from multiple remote computers, said central server receiving student information, selections of said one or more academic categories, said one or more performance indicators, or said metrics simultaneously over said communication network.

11. The method of claim 1, including the step of forming a student academic profile including said student report from multiple grade levels.

12. The method of claim 1, including the step of securing said electronic database and said communication network into a first security level permitting adding, deleting or modifying information in said electronic database and a second security level with read only privileges.

13. The method of claim 1, wherein said storing step includes the step of storing at least one monitoring assessment including a pass or a fail indicator.

14. The method of claim 13, wherein said displaying step includes the step of displaying said at least one monitoring assessment selectable via said interactive computer medium, wherein said selected monitoring assessment is included in said student report.

15. The method of claim 1, including the step of communicating with a standards server over said communication network, said standards server updating said one or more categories, said one or more performance indicators and said plurality of metrics over said communication network.

16. The method of claim 1, wherein said storing step includes the step of storing a disability and one or more impacts related thereto.

17. The method of claim 16, wherein said displaying step includes the step of displaying one or more of said disabilities and said related impacts via said interactive computer medium, wherein said combining step combines said one or more selected disabilities with said one or more selected impacts and based on said student information into a complete sentence presentable in said student report.

18. A method for streamlining data compilation and report generation, comprising the steps of:
storing one or more academic categories having one or more performance indicators in an electronic database, each of said one or more performance indicators comprising an academic strength or an academic weakness and forming a part of a sentence;
associating one or more metrics with each of said one or more performance indicators in said electronic database, each of said one or more metrics comprising a grade including a percentage or a fractional score and forming another part of said sentence;
displaying said one or more academic categories, said one or more performance indicators and at least one metric associated therewith via an interactive computer medium;
receiving data communications from at least two remote devices over a communication network, said data communications including student information and selections of said one or more academic categories, said one or more performance indicators and said at least one metric from said interactive computer medium;
communicating with a standards server over said communication network, said standards server updating said one or more categories, said one or more performance indicators and said one or more metrics over said communication network;
combining each of said received performance indicators with each of said received metrics and based on said student information, into at least one complete sentence presentable in a student report measuring an academic performance of a student for said one or more academic categories; and
injecting a variable field into said sentence, said variable field fillable based on said student information when presented in said student report.

19. The method of claim 18, including the step of generating a teaching feedback form and printing said student report or presenting said student report to said interactive computer medium, wherein said interactive computer medium comprises a computer monitor or a touch screen.

20. The method of claim 18, including the step of compiling said student report from said at least two remote devices simultaneously over said communication network, said compiling step further including the step of simultaneously adding, deleting, or modifying said student report from said at least two remote devices through respective interactive computer mediums.

21. The method of claim 18, including the steps of:
translating said student information into at least one gender-based pronoun usable in said at least one complete sentence as said variable field;
forming a student academic profile including said student report from multiple grade levels; and
securing said electronic database and said communication network into a first security level permitting adding, deleting or modifying information in said electronic database and a second security level with read only privileges.

22. The method of claim 18, wherein said storing step includes the step of storing at least one monitoring assessment including a pass or a fail indicator and said displaying step includes the step of displaying said at least one monitoring assessment selectable via said interactive computer medium, wherein said selected monitoring assessment is included in said student report, and further wherein said storing step includes the step of storing a disability and one or more impacts related thereto and said displaying step includes the step of displaying one or more of said disabilities and said related impacts via said interactive computer medium, wherein said combining step further includes combining said one or more selected disabilities with said one or more selected impacts and based on said student information, into one or more complete sentences presentable in said student report.

23. A method for streamlining data compilation and report generation, comprising the steps of:
storing one or more academic categories having one or more performance indicators, at least one monitoring assessment, and one or more disabilities in an electronic database, each of said one or more performance indicators, at least one monitoring assessment, and at least one disability form a part of one or more sentences;
associating one or more metrics with each of said one or more performance indicators and one or more impacts with each of said one or more disabilities, each of said one or more metrics and said one or more impacts forming another part of said one or more sentences;
displaying said one or more academic categories, said one or more performance indicators each with at least one metric associated therewith, and said one or more disabilities each with at least one impact associated therewith via an interactive computer medium;
receiving student information and selections of said one or more academic categories, said one or more performance indicators each with at least one metric, said at least one monitoring assessment, and said one or more disabilities each with at least one impact from said interactive computer medium over a communication network;
combining each of said received performance indicators with each of said received metrics and each of said received disabilities with each of said received impacts and based on said student information, into one or more complete sentences presentable in a student report measuring an academic performance of a student for said one or more academic categories along with said selected monitoring assessment;
adding, deleting, or modifying said student report simultaneously from at least two remote devices through respective interactive computer mediums; and
forming a student academic profile including said student report from multiple grade levels.

24. The method of claim 23, including the step of printing said student report or presenting said student report to said interactive computer medium, wherein said receiving step includes the step of receiving data communications from said at least two remote devices via said communication network.

25. The method of claim 23, including the step of compiling said student report from said at least two remote devices simultaneously over said communication network, wherein said interactive computer medium comprises a computer monitor or a touch screen.

26. The method of claim 23, including the steps of;
injecting a variable field into said one or more sentences, said variable field fillable based on said student information when presented in said student report;
translating said student information into at least one gender-based pronoun usable in said one or more complete sentences as said variable field;
establishing multiple connection requests in a central server from said at least two remote devices, said central server receiving student information, selections of said one or more academic categories, said one or more performance indicators and said related metrics, said one or more disabilities and said related impacts, and said monitoring assessment simultaneously over said communication network;
securing said electronic database and said communication network into a first security level permitting adding, deleting or modifying information in said electronic database and a second security level with read only privileges; and
communicating with a standards server over said communication network, said standards server updating said one or more categories, said one or more performance indicators and said one or more metrics, said at least one monitoring assessment, and said one or more disabilities and said one or more impacts over said communication network.

27. The method of claim 23, wherein said student information comprises a name and a gender.

28. The system of claim 23, wherein said at least two remote devices connect via a web-based software application communicating with said central server.

29. The system of claim 23, including the step of translating information in said electronic database from one language to another language.
